(19) United States
(12) Patent Application Publication
(10) Pub. No.: US 2026/0142111 A1
(43) Pub. Date: May 21, 2026

(54) RELAY

(71) Applicant: Xiamen Hongfa Electric Power Controls Co., Ltd., Xiamen (CN)

(72) Inventors: Wenguang Dai, Xiamen (CN); Meng Wang, Xiamen (CN); Songsheng Chen, Xiamen (CN)

(21) Appl. No.: 19/121,018

(22) PCT Filed: Oct. 9, 2023
(86) PCT No.: PCT/CN2023/123604

§ 371 Date: Apr. 14, 2025

(30) Foreign Application Priority Data
Oct. 12, 2022 (CN) 202211248732.3
Oct. 12, 2022 (CN) 202211249134.8

(51) Int. Cl. H01H 50/32; H01H 50/04; H01H 50/14; H01H 50/16; H01H 50/34; H01H 50/42; H01H 50/60; H01H 75/10

(52) U.S. Cl. CPC H01H 50/32; H01H 50/045; H01H 50/14; H01H 50/163; H01H 50/34; H01H 50/42; H01H 50/60; H01H 75/10

(57) ABSTRACT

A relay includes a contact container having a contact chamber; a pair of static lead-out terminals fixedly disposed relative to the contact container; a first magnetizer movably disposed within the contact chamber, and having a first and a second positions; a movable member including a movable contact piece and a second magnetizer, the first and second magnetizers are disposed at an opposite sides of the movable contact piece; the first distance between the first magnetizer and the second magnetizer in the first position is greater than the second distance between the first magnetizer and the second magnetizer in the second position; and a tripping assembly. Wherein the first magnetizer is connected to the contact container through the tripping assembly, and the tripping assembly is configured to release the first magnetizer when a magnetic attraction force between the first magnetizer and the second magnetizer exceeds a threshold.

### CROSS-REFERENCE

This disclosure is the U.S. national phase application of International Application No. PCT CN 2023/123604, filed on Oct. 9, 2023, which claims priority to Chinese patent application No. 202211248732.3 and 202211249134.8, both filed on Oct. 12, 2022, the entire contents of which are incorporated herein by reference.

### TECHNICAL FIELD

The present disclosure relates to the technical field of relays, and more particularly, to a high-voltage DC relay.

### BACKGROUND

A relay is an electronic control device that consists of a control system (also known as the input circuit) and a controlled system (also known as the output circuit). It is commonly used in automatic control circuits. Essentially, a relay functions as an “automatic switch” that uses a smaller current to control a larger current. As such, it plays roles in automatic regulation, safety protection, and circuit switching within electrical systems.

High-voltage DC relays are a type of relay. In order to solve the problem that the contact of high voltage DC relay bounces off because of the electric repulsion generated by short circuit current, related technologies typically employ an anti-short-circuit ring electromagnetic structure. Based on the placement of the upper yoke iron, these structures are further categorized into follow-up type and fixed type. Specifically, the follow-up type structure refers that the upper yoke iron is installed on the movable component of the relay, while the fixed type structure refers that the upper yoke iron is installed in a fixed position other than the movable component. However, although the fixed-type anti-short-circuit structure has strong anti-short-circuit capability, its breaking capacity is weakened due to the negative correlation between anti-short-circuit capability and breaking capacity. On the other hand, the follow-up type anti-short-circuit structure is influenced by the holding force of the movable iron core. When the short-circuit current is high, the iron core will break off, which will lead to the disconnection of contacts, and to increase the holding force of the moving iron core, it is necessary to increase the coil, which is contrary to the small size and light weight.

### SUMMARY

In one aspect of the present disclosure, a relay including:
a contact container having a contact chamber;
a pair of static lead-out terminals fixedly disposed relative to the contact container;
a first magnetizer movably disposed within the contact chamber, and having a first position and a second position relative to the contact container;
a movable member including a movable contact piece and a second magnetizer, wherein both ends of the movable contact piece are configured to come into contact with or separate from the pair of static lead-out terminals; the first magnetizer is disposed at a side of the movable contact piece facing the static lead-out terminals, and the second magnetizer is fixedly disposed at a side of the movable contact piece facing away from the static lead-out terminals, the second magnetizer is configured to form a magnetic circuit with the first magnetizer; in the first position, a distance between the first magnetizer and the second magnetizer is a first distance, and in the second position, a distance between the first magnetizer and the second magnetizer is a second distance, the first distance is greater than the second distance; and
a tripping assembly, wherein the first magnetizer is connected to the contact container through the tripping assembly, and the tripping assembly is configured to release the first magnetizer when a magnetic attraction force between the first magnetizer and the second magnetizer exceeds a threshold.

According to some embodiments of the present disclosure, wherein the pair of static lead-out terminals are connected to the contact container, at least a portion of each of the static lead-out terminals is located within the contact chamber.

According to some embodiments of the present disclosure, the first magnetizer is in the first position when a current flowing through the movable contact piece is less than or equal to a threshold current;
when a current flowing through the movable contact piece exceeds the threshold current, the tripping assembly releases the first magnetizer, causing the first magnetizer to move from the first position to the second position under the magnetic attraction force.

According to some embodiments of the present disclosure, the tripping assembly includes:
a first engaging member fixedly disposed relative to the contact container; and
a second engaging member having a locked position and a released position relative to the first engaging member;
wherein, in the locked position, the second engaging member is engaged with the first engaging member to keep the first magnetizer in the first position, and in the released position, the second engaging member is separated from the first engaging member, allowing the first magnetizer to move from the first position to the second position.

According to some embodiments of the present disclosure, the second engaging member is fixedly connected to the first magnetizer; the tripping assembly further includes:
a holding member, at least partially disposed within the contact chamber and fixedly arranged relative to the contact container; the first engaging member is fixedly connected to the holding member.

According to some embodiments of the present disclosure, the first magnetizer is movably connected to the holding member through a limiting structure, the limiting structure is configured to restrict a movement of the first magnetizer relative to the holding member from the first position to the second position.

According to some embodiments of the present disclosure, the limiting structure includes:
a limiting groove provided on one of the first magnetizer and the holding member, and extending along a movement direction of the movable contact piece; a stopping wall is provided at one end of the groove wall of the limiting groove closer to the second magnetizer; and
a limiting block provided on another of the first magnetizer and the holding member, the limiting block is slidably engaged with the limiting groove, and in the second position, the stopping wall abuts against the limiting block.

According to some embodiments of the present disclosure, in the first position, a first gap exists between the limiting block and the groove wall of the limiting groove;
in the second position, a second gap exists between the limiting block and the groove wall of the limiting groove;
the first gap is smaller than the second gap.

According to some embodiments of the present disclosure, the contact container further includes a pair of first through-holes and a second through-hole, both the first through-holes and the second through-hole are in communication with the contact chamber; the pair of static lead-out terminals respectively pass through the pair of first through-holes;
the relay further includes a connector passing through the second through-hole, the connector includes a first end and a second end, the first end is connected to the contact container, and the second end is connected to the holding member.

According to some embodiments of the present disclosure, the contact container includes:
a yoke plate; and
an insulating cover connected to the yoke plate; the insulating cover and the yoke plate enclose the contact chamber;
wherein the first through-holes and the second through-hole are provided on the insulating cover, and the first end of the connector is connected to an outer wall surface of the insulating cover.

According to some embodiments of the present disclosure, the insulating cover includes a ceramic cover and a frame member, the ceramic cover includes a top wall and a side wall, one end of the side wall is connected around a periphery of the top wall, and another end of the side wall is connected to the yoke plate through the frame member;
the first through-holes and the second through-hole are provided on the top wall; on an outer wall surface of the top wall, a first metallization layer is provided around a periphery of the first through-holes, and a second metallization layer is provided around a periphery of the second through-hole;
the static lead-out terminals are welded to the top wall through the first metallization layer, and the first end of the connector is welded to the top wall through the second metallization layer.

According to some embodiments of the present disclosure, the top wall and the side wall are of an integrated structure; or, the top wall and the side wall are of a separate structure.

According to some embodiments of the present disclosure, the holding member is spaced apart from an inner wall surface of the top wall.

According to some embodiments of the present disclosure, the contact container includes:
a yoke plate; and
an insulating cover connected to the yoke plate; the insulating cover and the yoke plate enclose the contact chamber;
the relay further includes a fixing frame disposed within the contact chamber and fixedly connected to the yoke plate, the holding member is fixedly connected to the fixing frame.

According to some embodiments of the present disclosure, the holding member is located between the pair of static lead-out terminals.

According to some embodiments of the present disclosure, the holding member is made of a metal material.

According to some embodiments of the present disclosure, the second engaging member is fixedly connected to the first magnetizer;
the first engaging member and the second engaging member are magnetically connected.

According to some embodiments of the present disclosure, one of the first engaging member and the second engaging member is a permanent magnet, and another is an iron block.

According to some embodiments of the present disclosure, the second engaging member is fixedly connected to the first magnetizer;
the first engaging member and the second engaging member are connected by a snap-fit connection.

According to some embodiments of the present disclosure, one of the first engaging member and the second engaging member includes a clamping post and a convex bump protruding from an outer periphery of the clamping post;
another of the first engaging member and the second engaging member includes a clamping sleeve and a clamping groove recessed on an inner peripheral wall of the clamping sleeve;
the clamping post is inserted into the clamping sleeve, and the convex bump is engaged with the clamping groove.

According to some embodiments of the present disclosure, the first magnetizer has an opening;
the first engaging member includes a guide post passing through the opening and fixedly arranged relative to the contact container;
the second engaging member includes an elastic snap ring movably sleeved on an end of the guide post closer to the second magnetizer;
in the locked position, the elastic snap ring prevents the first magnetizer from moving toward the second magnetizer relative to the guide post.

According to some embodiments of the present disclosure, a stopping structure is further provided between the guide post and the first magnetizer, configured to stop the first magnetizer at the second position when the elastic snap ring is in the released position.

According to some embodiments of the present disclosure, the stopping structure includes:
a first stopping portion provided on the first magnetizer; and
a second stopping portion provided on the guide post;
wherein, when the first magnetizer is in the second position, the first stopping portion and the second stopping portion abut against each other.

According to some embodiments of the present disclosure, in the released position, the elastic snap ring is detached from the guide post; or,
in the released position, the elastic snap ring is clamped between the first magnetizer and the second stopping portion.

According to some embodiments of the present disclosure, a side of the first magnetizer facing the second magnetizer is provided with a groove, the groove is in communication with the opening;
when the first magnetizer is in the first position, the elastic snap ring and an end of the guide post closer to the second magnetizer are accommodated in the groove.

According to some embodiments of the present disclosure, in the second position, the second distance between the first magnetizer and the second magnetizer is equal to zero.

Another aspect of the present disclosure, a relay including:
a contact container including a yoke plate and an insulating cover, the insulating cover is connected to one side of the yoke plate to form a contact chamber;
a pair of static lead-out terminals fixedly disposed relative to the insulating cover ;
a first magnetizer movably disposed within the contact chamber, and having a first position and a second position relative to the contact container; the first magnetizer has an opening;
a movable member including a movable contact piece and a second magnetizer, wherein both ends of the movable contact piece are configured to come into contact with or separate from the pair of static lead-out terminals; the first magnetizer is disposed at a side of the movable contact piece facing the static lead-out terminals, and the second magnetizer is fixedly disposed at a side of the movable contact piece facing away from the static lead-out terminals, the second magnetizer is configured to form a magnetic circuit with the first magnetizer; in the first position, a distance between the first magnetizer and the second magnetizer is a first distance, and in the second position, a distance between the first magnetizer and the second magnetizer is a second distance, the first distance is greater than the second distance; and
a tripping assembly including a guide post and an elastic snap ring, the guide post is passing through the opening and fixedly arranged relative to the insulating cover; the elastic snap ring is movably sleeved on the guide post; the elastic snap ring has a locked position and a released position relative to the guide post, in the locked position, the elastic snap ring prevents the first magnetizer from moving toward the second magnetizer relative to the guide post, so that the first magnetizer is located in the first position, and in the released position, the elastic snap ring is separated from the locked position, allowing the first magnetizer to move from the first position to the second position.

According to some embodiments of the present disclosure, the pair of static lead-out terminals connected to the insulating cover, with at least a portion of the static lead-out terminals located within the contact chamber.

According to some embodiments of the present disclosure, the first magnetizer is in the first position when a current flowing through the movable contact piece is less than or equal to a threshold current; when a current flowing through the movable contact piece exceeds the threshold current, the first magnetizer is attracted by the magnetic attraction force between the first magnetizer and the second magnetizer to move from the first position to the second position.

According to some embodiments of the present disclosure, a stopping structure is further provided between the guide post and the first magnetizer, configured to stop the first magnetizer at the second position when the elastic snap ring is in the released position.

According to some embodiments of the present disclosure, the stopping structure includes a first stopping portion provided on the first magnetizer; and a second stopping portion provided on the guide post; wherein, when the first magnetizer is in the second position, the first stopping portion and the second stopping portion abut against each other.

According to some embodiments of the present disclosure, in the released position, the elastic snap ring is detached from the guide post; or, in the released position, the elastic snap ring is clamped between the first magnetizer and the second stopping portion.

According to some embodiments of the present disclosure, a side of the first magnetizer facing the second magnetizer is provided with a groove, the groove is in communication with the opening; when the first magnetizer is in the first position, the elastic snap ring and an end of the guide post closer to the second magnetizer are accommodated in the groove.

According to some embodiments of the present disclosure, the contact container further includes a pair of first through-holes and a fourth through-hole, both the first through-holes and the fourth through-hole are in communication with the contact chamber; the pair of static lead-out terminals are respectively passing through the pair of first through-holes; the guide post passes through the fourth through-hole and includes a third end and a fourth end, the third end is connected to the contact container, and the elastic snap ring is sleeved on the fourth end.

According to some embodiments of the present disclosure, the first through-holes and the fourth through-hole are provided on the insulating cover, and the third end of the guide post is connected to the insulating cover.

According to some embodiments of the present disclosure, the insulating cover includes a ceramic cover and a frame member, the ceramic cover includes a top wall and a side wall, one end of the side wall is connected around a periphery of the top wall, and another end of the side wall is connected to the yoke plate through the frame member; the first through-holes and the fourth through-hole are provided on the top wall, and on an outer wall surface of the top wall, a first metallization layer is provided around a periphery of the first through-holes, and a third metallization layer is provided around a periphery of the fourth through-hole; the static lead-out terminals are welded to the top wall through the first metallization layer, and the third end of the guide post is welded to the top wall through the third metallization layer.

According to some embodiments of the present disclosure, the top wall and the side wall are of an integrated structure; or, the top wall and the side wall are of a separate structure and are connected by welding.

According to some embodiments of the present disclosure, the first magnetizer is spaced apart from an inner wall surface of the top wall.

According to some embodiments of the present disclosure, the third end of the guide post is connected to the contact container through a welding terminal.

According to some embodiments of the present disclosure, the relay further includes a fixing frame disposed within the contact chamber and fixedly connected to the yoke plate; the guide post is fixedly connected to the fixing frame.

According to some embodiments of the present disclosure, in the second position, the second distance between the first magnetizer and the second magnetizer is equal to zero.

### BRIEF DESCRIPTION OF THE DRAWINGS

FIG. 1 shows a perspective schematic diagram of a relay according to a first embodiment of the present disclosure, with the housing, the electromagnetic unit, and the arc extinguishing unit removed.

FIG. 2 shows a schematic diagram of FIG. 1 with the ceramic cover and the frame member removed.

FIG. 3 shows a top view schematic diagram of FIG. 1.

FIG. 4 shows a cross-sectional view taken along line A-A in FIG. 3.

FIG. 5 shows an exploded schematic diagram of FIG. 1.

FIG. 6 shows a cross-sectional view taken along line B-B in FIG. 3, with the ceramic cover and separated frame member removed, and the first magnetizer in the first position.

FIG. 7 shows a partial enlarged view of part X1 in FIG. 6.

FIG. 8 shows a cross-sectional view taken along line B-B in FIG. 3, with the ceramic cover and the frame member removed, and the first magnetizer in the second position.

FIG. 9 shows a partial enlarged view of part Y1 in FIG. 8.

FIG. 10 shows a partial enlarged view of part Z in FIG. 2.

FIG. 11 shows a schematic diagram of the holding member fixedly connected to the fixing frame.

FIG. 12 shows a perspective schematic diagram of a relay according to a second embodiment of the present disclosure, with the housing, the electromagnetic unit, the arc extinguishing unit, the ceramic cover, and the frame member removed.

FIG. 13 shows a cross-sectional view taken along line C-C in FIG. 12 after assembling the ceramic cover and frame member.

FIG. 14 shows an exploded schematic diagram of FIG. 12.

FIG. 15 shows a cross-sectional view taken along line D-D in FIG. 12, with the first magnetizer in the first position.

FIG. 16 shows a partial enlarged view of part X2 in FIG. 15.

FIG. 17 shows a cross-sectional view taken along line D-D in FIG. 12, with the first magnetizer in the second position.

FIG. 18 shows a partial enlarged view of part Y2 in FIG. 17.

FIG. 19 shows a perspective schematic diagram of a relay according to a third embodiment of the present disclosure, with the housing, the electromagnetic unit, the arc extinguishing unit, the ceramic cover, and the frame member removed.

FIG. 20 shows a schematic diagram of FIG. 19 with the ceramic cover and the frame member removed.

FIG. 21 shows a top view schematic diagram of FIG. 19.

FIG. 22 shows a cross-sectional view taken along line E-E in FIG. 21.

FIG. 23 shows an exploded schematic diagram of FIG. 19.

FIG. 24 shows a cross-sectional view taken along line F-F in FIG. 21, with the ceramic cover and the frame member removed, and the first magnetizer in the first position.

FIG. 25 shows a partial enlarged view of part X3 in FIG. 24.

FIG. 26 shows a cross-sectional view taken along line F-F in FIG. 21, with the ceramic cover and the frame member removed, and the first magnetizer in the second position.

FIG. 27 shows a partial enlarged view of part Y3 in FIG. 26.

FIG. 28 shows a perspective schematic diagram of a relay according to a fourth embodiment of the present disclosure, with the housing, the electromagnetic unit, the arc extinguishing unit, the ceramic cover, and the frame member removed.

FIG. 29 shows a schematic diagram of FIG. 28 with the ceramic cover and frame member removed.

FIG. 30 shows a top view schematic diagram of FIG. 28.

FIG. 31 shows an exploded schematic diagram of FIG. 28.

FIG. 32 shows a cross-sectional view taken along line G-G in FIG. 30, with the ceramic cover and the frame member removed, and the first magnetizer in the first position.

FIG. 33 shows a partial enlarged view of part X4 in FIG. 32.

FIG. 34 shows a cross-sectional view taken along line G-G in FIG. 30, with the ceramic cover and the frame member removed, and the first magnetizer in the second position.

FIG. 35 shows a partial enlarged view of part Y4 in FIG. 34.

FIG. 36 shows an exploded schematic diagram of the relay according to the present disclosure.

### REFERENCE NUMERALS

10, contact container; 101, contact chamber; 102, first through-hole; 103, second through-hole; 104, fourth through-hole; 105, welding terminal; 11a, insulating cover; 11, ceramic cover; 111, top wall; 112, side wall; 113, first metallization layer; 114, second metallization layer; 115, third metallization layer; 12, frame member; 13, yoke plate; 131, third through-hole; 20, static lead-out terminal; 30, connector; 31, first end of the connector; 32, second end of the connector; 40, first magnetizer; 401, groove; 41, opening; 42, holding member; 43, limiting structure; 431, limiting groove; 432, limiting block; 433, stopping wall; 434, limiting wall; 50, push rod assembly; 51, push rod; 52, base; 53, movable member; 54, movable contact piece; 55, second magnetizer; 56, elastic member; 57, sliding structure; 571, limiting portion; 572, limiting hole; 70, fixing frame; 80, tripping assembly; 810, first engaging member; 811, clamping post; 812, convex bump; 820, second engaging member; 821, clamping sleeve; 822, clamping groove; 830, guide post; 831, third end; 832, fourth end; 840, elastic snap ring; 850, stopping structure; 851, first stopping portion; 852, second stopping portion; 1100, housing; 1110, first housing; 1120, second housing; 1130, exposure hole; 1200, electromagnetic unit; 1210, bobbin; 1220, coil; 1230, stationary iron core; 1240, movable iron core; 1250, reset member; 1300, arc extinguishing unit; 1310, arc extinguishing magnet; 1320, yoke clip; 1400, sealing unit; 1410, metal cover; P1, first position; P2, second position; H1, first distance; H2, second distance; D1, movement direction; D2, length direction.

### DETAILED DESCRIPTION

The exemplary embodiments will now be described more fully with reference to the accompanying drawings. However, the exemplary embodiments can be implemented in various forms and should not be construed as limited to the embodiments set forth herein. Instead, these embodiments are provided to make the present disclosure thorough and complete, and to fully convey the concepts of the exemplary embodiments to those skilled in the art. The same reference numerals in the drawings denote the same or similar structures, and thus detailed descriptions thereof will be omitted.

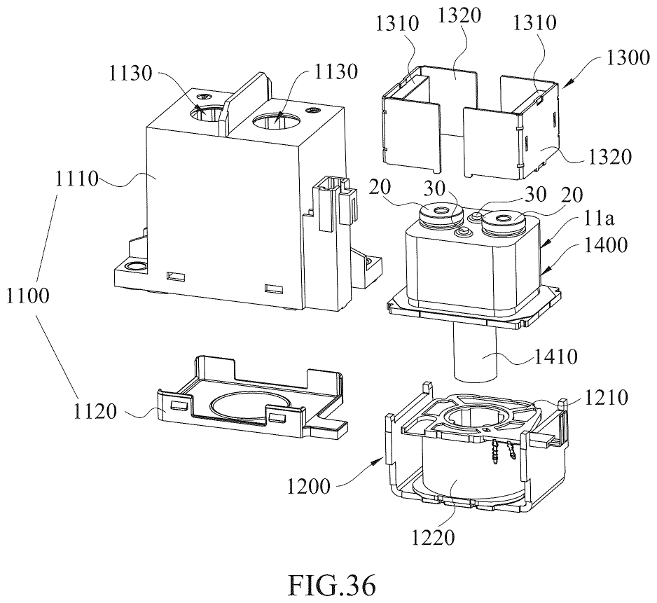

As shown in FIG. 36, FIG. 36 illustrates an exploded schematic diagram of the relay according to the present disclosure. The relay includes a housing 1100, an electromagnetic unit 1200, an arc extinguishing unit 1300, and a sealing unit 1400. The sealing unit 1400 is disposed within the housing 1100, and the top of the static lead-out terminal of the sealing unit 1400 is exposed on the outer surface of the housing 1100 through an exposure hole 1130 of the housing 1100. The electromagnetic unit 1200 and the arc extinguishing unit 1300 are both arranged within the housing 1100.

As an example, the housing 1100 includes a first housing 1110 and a second housing 1120, which are snap-fitted together to form a chamber for accommodating the electromagnetic unit 1200, the arc extinguishing unit 1300, and the sealing unit 1400.

The arc extinguishing unit 1300 is used to extinguish arcs generated between the static lead-out terminal of the sealing unit 1400 and the movable contact piece.

As an example, the arc extinguishing unit 1300 includes two arc extinguishing magnets 1310. The arc extinguishing magnets 1310 may be permanent magnets, and each arc extinguishing magnet 1310 may be generally rectangular in shape. The two arc extinguishing magnets 1310 are respectively arranged on both sides of the sealing unit 1400 and are oppositely positioned along the length direction of the movable contact piece.

By arranging two oppositely positioned arc extinguishing magnets 1310, a magnetic field can be formed around the static lead-out terminal and the movable contact piece. Therefore, arcs generated between the static lead-out terminal and the movable contact piece is stretched away from each other under the action of the magnetic field, achieving arc extinguishing.

The arc extinguishing unit 1300 further includes two yoke clips 1320, which are correspondingly arranged with the two arc extinguishing magnets 1310. Moreover, the two yoke clips 1320 surround the sealing unit 1400 and the two arc extinguishing magnets 1310. The design of the yoke clips 1320 surrounding the arc extinguishing magnets 1310 prevents the magnetic field generated by the arc extinguishing magnets 1310 from diffusing outward, thereby ensuring the arc extinguishing effect. The yoke clips 1320 are made of soft magnetic materials, which may include but are not limited to iron, cobalt, nickel, and their alloys.

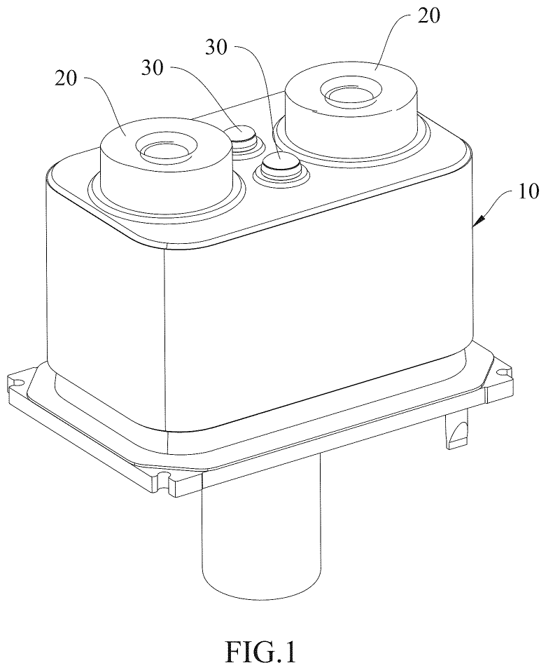

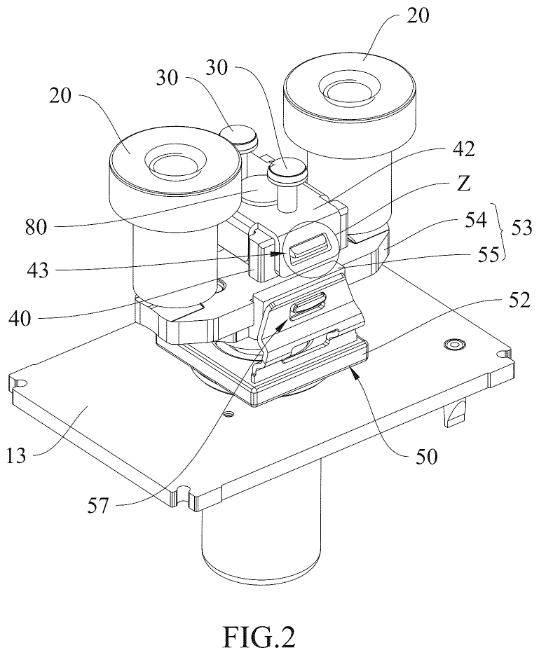

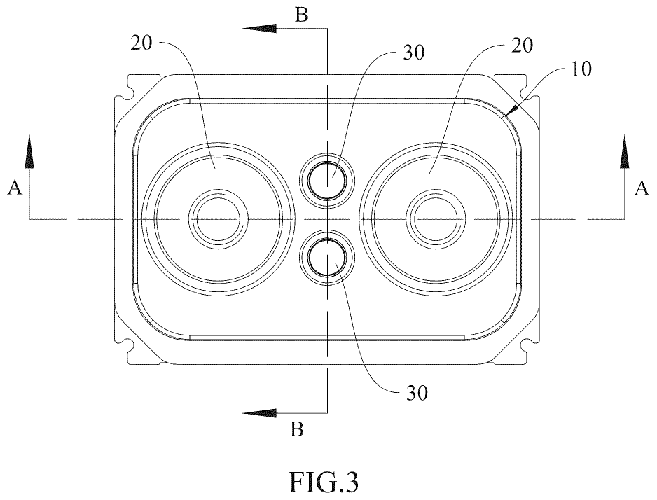

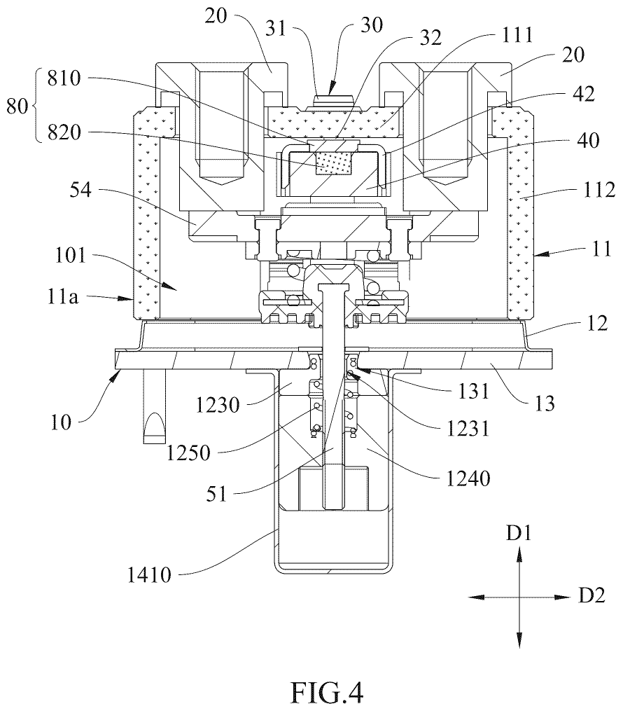

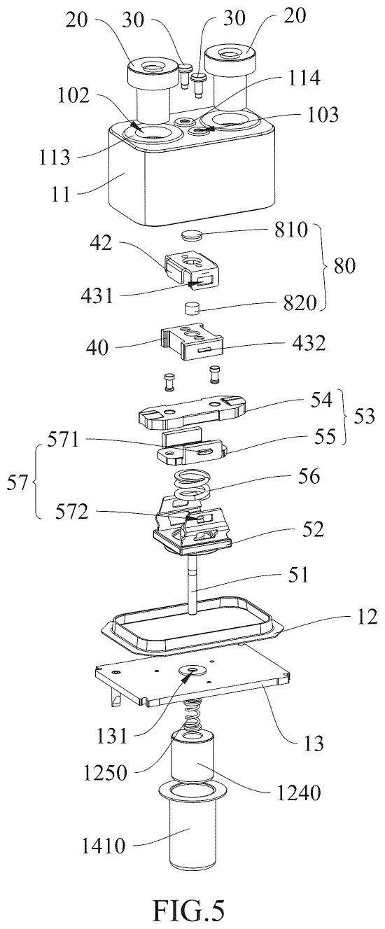

As shown in FIGS. 1 to 5, FIG. 1 illustrates a perspective schematic diagram of the relay according to the first embodiment of the present disclosure, with the housing, the electromagnetic unit, and the arc extinguishing unit removed. FIG. 2 shows a schematic diagram of FIG. 1 with the ceramic cover 11 and frame member 12 removed. FIG. 3 shows a top view schematic diagram of FIG. 1. FIG. 4 shows a cross-sectional view taken along line A-A in FIG. 3. FIG. 5 shows an exploded schematic diagram of FIG. 1.

The sealing unit 1400 of the present disclosure includes a contact container 10, a pair of static lead-out terminals 20, a push rod assembly 50, a first magnetizer 40, and a tripping assembly 80.

It should be understood that the terms “include” and “have” and any variations thereof in the present disclosure are intended to cover non-exclusive inclusion. For example, a process, method, system, product, or device that includes a series of steps or units is not limited to the listed steps or units, but may optionally include steps or units not listed, or may optionally include other steps or components inherent to such processes, methods, products, or devices.

The contact container 10 has a contact chamber 101 inside. The contact container 10 may include an insulating cover 11a and a yoke plate 13, with the insulating cover 11a covering one side surface of the yoke plate 13, and the insulating cover 11a and the yoke plate 13 together enclose to form the contact chamber 101.

The insulating cover 11a includes a ceramic cover 11 and a frame member 12. The ceramic cover 11 is connected to the yoke plate 13 through the frame member 12. The frame member 12 may be a ring-shaped metal component, such as an iron-nickel alloy, with one end connected to the edge of the opening of the ceramic cover 11, for example, by laser welding, brazing, resistance welding, adhesive bonding, etc. The other end of the frame member 12 is connected to the yoke plate 13, also by laser welding, brazing, resistance welding, adhesive bonding, etc. The arrangement of the frame member 12 between the ceramic cover 11 and the yoke plate 13 facilitates the connection between the ceramic cover 11 and the yoke plate 13.

The ceramic cover 11 includes a top wall 111 and a side wall 112, with one end of the side wall 112 connected around the periphery of the top wall 111, and the other end of the side wall 112 connected to the yoke plate 13 through the frame member 12.

The contact container 10 further has a pair of first through-holes 102 and a second through-hole 103, both of which are in communication with the contact chamber 101. The first through-holes 102 are used for the static lead-out terminals 20 to pass through, and the second through-hole 103 is used for a connector 30 to pass through.

As an example, the first through-holes 102 and the second through-hole 103 are both provided on the top wall 111 of the ceramic cover 11. The second through-hole 103 may be located between the two first through-holes 102, meaning that the connector 30 is arranged between the pair of static lead-out terminals 20.

The pair of static lead-out terminals 20 are connected to the contact container 10, with at least a portion of each static lead-out terminal 20 located within the contact chamber 101. One of the pair of static lead-out terminals 20 serves as a current input terminal, and the other serves as a current output terminal.

The pair of static lead-out terminals 20 respectively pass through the pair of first through-holes 102 and connected to the top wall 111 of the ceramic cover 11, for example, by welding.

The bottom of the static lead-out terminal 20 serves as static contacts, which may be integrally or separately arranged at the bottom of the static lead-out terminal 20.

The first magnetizer 40 is movably disposed within the contact chamber 101 and has a first position P1 and a second position P2 relative to the contact container 10. That is, the first magnetizer 40 is arranged within the contact chamber 101 and can move from the first position P1 to the second position P2 relative to the contact container 10.

The push rod assembly 50 is movably connected to the contact container 10 along the axial direction of the rod (i.e., along the movement direction D1 of the movable contact piece). The push rod assembly 50 may include a push rod 51, a base 52, a movable member 53, and an elastic member 56.

The yoke plate 13 has a third through-hole 131, which penetrates through two opposite sides of the yoke plate 13 along its thickness direction and is in communication with the contact chamber 101 of the contact container 10. The push rod 51 movably passes through the third through-hole 131 along its axial direction. One axial end of the push rod 51 is provided with the base 52, with at least a portion of the base 52 located within the contact chamber 101.

The movable member 53 is movably connected to the base 52 along the axial direction of the push rod 51. The movable member 53 includes a movable contact piece 54 and a second magnetizer 55, with both ends of the movable contact piece 54 configured to come into contact with or separate from the pair of static lead-out terminals 20. The first magnetizer 40 is arranged at the side of the movable contact piece 54 facing the static lead-out terminals 20, and the second magnetizer 55 is fixedly disposed at the side of the movable contact piece 54 opposite to the static lead-out terminals 20. That is, along the axial direction of the push rod 51, the movable contact piece 54 is located between the first magnetizer 40 and the second magnetizer 55. The first magnetizer 40 and the second magnetizer 55 are used to form a magnetic circuit.

As an example, the second magnetizer 55 and the movable contact piece 54 may be fixedly connected by rivets, but are not limited thereto.

It should be understood that both the first magnetizer 40 and the second magnetizer 55 may be made of materials such as iron, cobalt, nickel, and their alloys.

In one embodiment, the first magnetizer 40 may be of a linear shape, and the second magnetizer 55 may be U-shaped, but are not limited thereto.

It should be understood that both the first magnetizer 40 and the second magnetizer 55 may include multiple stacked magnetic sheets.

The two ends of the movable contact piece 54 are used to contact the bottom of the pair of static lead-out terminals 20, achieving contact closure. The two ends of the movable contact piece 54 along its length direction D2 may serve as movable contacts. The movable contacts at the two ends of the movable contact piece 54 may protrude from other parts of the movable contact piece 54 or may be flush with other parts.

It should be understood that the movable contacts may be integrally or separately arranged at the two ends of the movable contact piece 54 along its length direction D2.

The elastic member 56 is connected between the movable member 53 and the base 52 and is used to apply an elastic force to the movable member 53 toward the static lead-out terminals 20.

As an example, one end of the elastic member 56 abuts against the base 52, and the other end abuts against the second magnetizer 55 of the movable member 53. Of course, in other embodiments, the second magnetizer 55 may have a through-hole, and the other end of the elastic member 56 may pass through the through-hole of the second magnetizer 55 and abut against the movable contact piece 54.

The first magnetizer 40 is connected to the contact container 10 through the tripping assembly 80, and the tripping assembly 80 is used to release the first magnetizer 40 when the magnetic attraction force between the first magnetizer 40 and the second magnetizer 55 exceeds a threshold.

As shown in FIG. 5, the push rod assembly 50 further includes a sliding structure 57, which is connected between the base 52 and the movable member 53, allowing the movable member 53 to slide relative to the base 52. The sliding structure 57 includes a limiting hole 572 and a limiting portion 571 that cooperate with each other. The limiting portion 571 is slidably inserted into the limiting hole 572.

In this embodiment, the base 52 is directly connected to the movable member 53 through the limiting structure 57, making the assembly between the base 52 and the movable member 53 simpler. Moreover, since there are no other components above the movable member 53, interference between these components and the first magnetizer 40 during overtravel is avoided.

It should be understood that the limiting hole 572 may be a through-hole or a blind hole.

As an example, the base 52 is provided with the limiting hole 572, and the movable member 53 is provided with the limiting portion 571. Further, the second magnetizer 55 is provided with the limiting portion 571.

Of course, in other embodiments, the push rod assembly 50 may also adopt other structures, which will not be listed here.

Please continue to refer to FIGS. 4, 5, and 36. The sealing unit 1400 further includes a metal cover 1410, which is connected to the side of the yoke plate 13 opposite to the insulating cover 11a and covers the third through-hole 131 on the yoke plate 13. The metal cover 1410 and the yoke plate 13 enclose a chamber for accommodating the stationary iron core 1230 and the movable iron core 1240 of the electromagnetic unit 1200, which will be described in detail below.

The electromagnetic unit 1200 includes a coil frame 1210, a coil 1220, a stationary iron core 1230, a movable iron core 1240, and a reset member 1250. The coil frame 1210 is hollow and cylindrical and is made of insulating material. The metal cover 1410 is passed through the coil frame 1210. The coil 1220 is wound around the coil frame 1210. The stationary iron core 1230 is fixedly arranged within the metal cover 1410, with a portion of the stationary iron core 1230 extending into the third through-hole 131. The stationary iron core 1230 has a perforation 1231, which is aligned with the third through-hole 131 and is used for the push rod 51 to pass through. The movable iron core 1240 is movably arranged within the metal cover 1410 and is positioned opposite to the stationary iron core 1230. The movable iron core 1240 is connected to the push rod 51 and is used to be attracted by the stationary iron core 1230 when the coil 1220 is energized. The movable iron core 1240 and the push rod 51 may be connected by screwing, riveting, welding, or other methods.

The reset member 1250 is located inside the metal cover 1410 and is arranged between the stationary iron core 1230 and the movable iron core 1240. It is used to reset the movable iron core 1240 when the coil 1220 is de-energized. The reset member 1250 may be a spring and is sleeved on the outside of the push rod 51.

It should be noted that when the coil 1220 is energized, the movable iron core 1240 can drive the push rod assembly 50 to move upward through the push rod 51. When the movable member 53 contacts the static lead-out terminals 20, the movable member 53 is stopped by the static lead-out terminals 20, while the push rod 51 and the base 52 continue to move upward until the overtravel is completed.

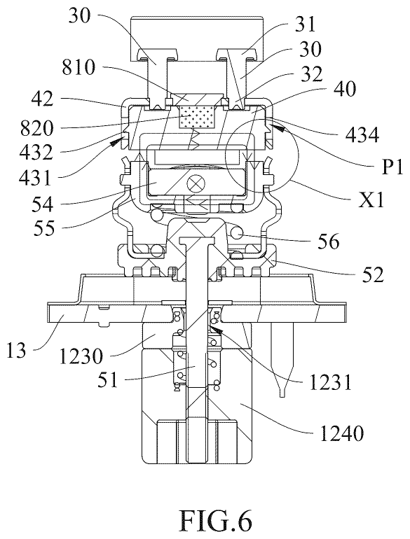

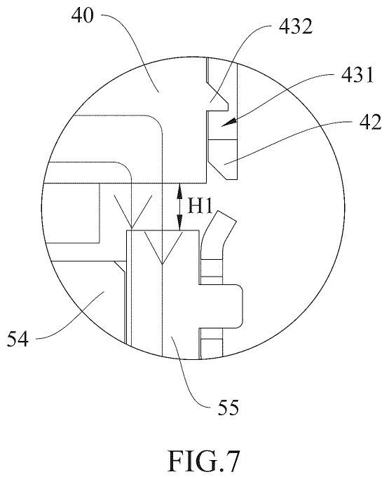

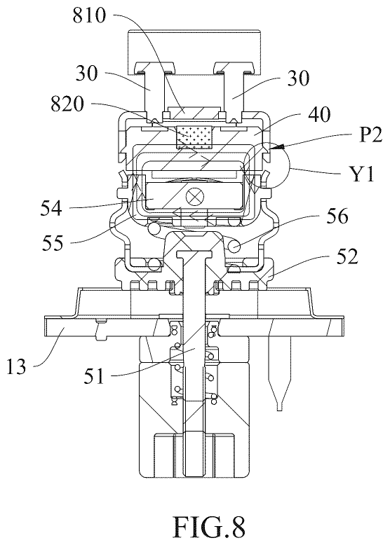

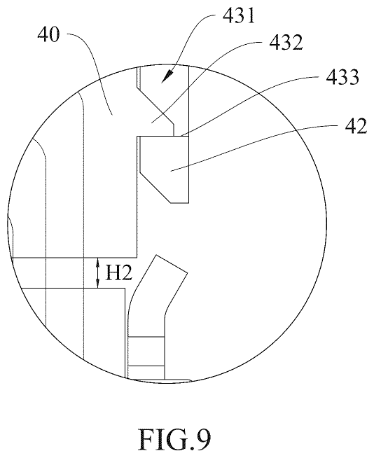

As shown in FIG. 6 to FIG. 9, FIG. 6 shows a cross-sectional view along line B-B in FIG. 3, with the ceramic cover and the frame member omitted, and the first magnetizer 40 in the first position P1. FIG. 7 shows a partial enlarged view of part X1 in FIG. 6. FIG. 8 illustrates a cross-sectional view along line B-B in FIG. 3, with the ceramic cover and frame member removed, and the first magnetizer 40 in the second position P2. FIG. 9 shows a partial enlarged view of part Y1 in FIG. 8. In the first position P1, the distance between the first magnetizer 40 and the second magnetizer 55 is a first distance H1. In the second position P2, the distance between the first magnetizer 40 and the second magnetizer 55 is a second distance H2, and the first distance H1 is greater than the second distance H2.

It should be noted that the movable contact piece 54 in the present disclosure is positioned between the first magnetizer 40 and the second magnetizer 55. When both ends of the movable contact piece 54 are in contact with the pair of static lead-out terminals 20, a magnetic circuit is formed around the movable contact piece 54 between the first magnetizer 40 and the second magnetizer 55, thereby generating a magnetic attraction force along the direction of contact pressure between the first magnetizer 40 and the second magnetizer 55. This magnetic attraction force can counteract the electromagnetic repulsion force generated between the movable contact piece 54 and the static lead-out terminals 20 due to short-circuit current, ensuring that the movable contact piece 54 and the static lead-out terminals 20 do not bounce off.

It is understandable that when the current value flowing through the movable contact piece 54 is constant, the magnitude of the magnetic attraction force generated between the first magnetizer 40 and the second magnetizer 55 is inversely proportional to the distance between them. The smaller the distance, the greater the magnetic attraction force.

In order to counteract the electromagnetic repulsion force generated by short-circuit current and prevent the movable contact piece 54 from bouncing off the static lead-out terminals 20, the distance between the first magnetizer 40 and the second magnetizer 55 should be designed to be smaller, thereby increasing the magnetic attraction force between them.

In order to facilitate timely breaking, the distance between the first magnetizer 40 and the second magnetizer 55 should be designed to be larger, thereby reducing the magnetic attraction force between them and avoiding excessive magnetic attraction force that could affect timely breaking.

From this, it can be seen that when the distance between the first magnetizer 40 and the second magnetizer 55 is fixed, it is impossible to consider both anti-short circuit and ultimate breaking capacity.

In this embodiment, by making the first magnetizer 40 movable, the distance between the first magnetizer 40 and the second magnetizer 55 can be adjusted according to the magnitude of the current value, thereby changing the magnetic attraction force generated between them to balance short-circuit current resistance and ultimate breaking capacity.

Specifically, as shown in FIG. 6 and FIG. 7, the relay is in normal working condition, the current value flowing through the movable contact piece 54 is less than or equal to a threshold current, for example, less than 2000 A. Since the current value is small at this case, the magnetic attraction force between the first magnetizer 40 and the second magnetizer 55 is also small, and the magnetic attraction force is less than or equal to a threshold. The threshold can be understood as the magnitude of the magnetic attraction force when the tripping assembly 80 separates away, allowing the first magnetizer 40 to move relative to the contact container 10. Since the magnetic attraction force between the first magnetizer 40 and the second magnetizer 55 is less than the threshold, the coupling force of the tripping assembly 80 can counteract the magnetic attraction force between the first magnetizer 40 and the second magnetizer 55, keeping the first magnetizer 40 in the first position P1. When the first magnetizer 40 is in the first position P1, the distance between the first magnetizer 40 and the second magnetizer 55 is the first distance H1. For example, the first distance H1 can be 1.5 mm, but is not limited to this.

It is understandable that the magnitude of the threshold current can be adjusted according to different types of relays. For example, if the maximum breaking current of the relay is large, the threshold current can also be set larger to ensure that the first magnetizer 40 remains in the first position P1 during the normal working state of the relay and does not move to the second position P2.

As shown in FIG. 8 and FIG. 9, when the current value flowing through the movable contact piece 54 exceeds the threshold current, for example, greater than 2000 A, since the magnetic attraction force between the first magnetizer 40 and the second magnetizer 55 is proportional to the current value, the larger the current value, the greater the magnetic attraction force between the first magnetizer 40 and the second magnetizer 55. When the magnetic attraction force exceeds the aforementioned threshold, that is, when the magnetic attraction force is greater than the coupling force of the tripping assembly 80, the tripping assembly 80 releases the first magnetizer 40, allowing it to be attracted by the magnetic force and move toward the second magnetizer 55 (i.e., moving from the first position P1 to the second position P2). This reduces the distance between the first magnetizer 40 and the second magnetizer 55. Since the magnetic distance is inversely proportional to the magnetic attraction force, the smaller the magnetic distance, the greater the magnetic attraction forces. When a short-circuit current (far exceeding the threshold current) flows, the first magnetizer 40 moves to the second position P2, at which point the distance between the first magnetizer 40 and the second magnetizer 55 is a second distance H2. The second distance H2 is smaller than the first distance H1, and the reduction in distance increases the magnetic attraction force between the first magnetizer 40 and the second magnetizer 55. Therefore, the first magnetizer 40 can attract the second magnetizer 55 with this increased magnetic attraction force, which can counteract the electromagnetic repulsion force generated by the short-circuit current, ensuring that the movable contact piece 54 does not bounce off the static lead-out terminals 20, thereby achieving anti-short circuit.

It can be seen that the relay of the present disclosure, on one hand, the first magnetizer 40 is movably arranged within the contact chamber 101, allowing the distance between the first magnetizer 40 and the second magnetizer 55 to be adjusted according to the current value, thereby changing the magnetic attraction force between them. This not only meets the requirements for breaking but also satisfies the need for anti-short circuit. On the other hand, the first magnetizer 40 is connected to the contact container 10 through the tripping assembly 80, and when the magnetic attraction force between the first magnetizer 40 and the second magnetizer 55 exceeds the threshold, the tripping assembly 80 releases the first magnetizer 40, thereby adjusting the magnetic distance between the first magnetizer 40 and the second magnetizer 55. The design of the tripping assembly 80 ensures faster response speed and higher sensitivity to short-circuit conditions.

As shown in FIG. 4 and FIG. 5, the tripping assembly 80 includes a first engaging member 810, a second engaging member 820, and a holding member 42. At least part of the holding member 42 is arranged within the contact chamber 101 and is fixed relative to the contact container 10. The first engaging member 810 is fixedly connected to the holding member 42, and the second engaging member 820 is fixedly connected to the first magnetizer 40. The position of the second engaging member 820 relative to the first engaging member 810 includes a locked position and a released position. In the locked position, the second engaging member 820 and the first engaging member 810 are engaged, keeping the first magnetizer 40 in the first position P1. In the released position, the second engaging member 820 and the first engaging member 810 are disengaged, allowing the first magnetizer 40 to move from the first position P1 to the second position P2.

Specifically, the first engaging member 810 and the second engaging member 820 can be connected through their coupling force. When the magnetic attraction force between the first magnetizer 40 and the second magnetizer 55 is less than or equal to the threshold, that is, less than or equal to the coupling force between the first engaging member 810 and the second engaging member 820, the second engaging member 820 remains in the locked position relative to the first engaging member 810, and thus the first magnetizer 40 cannot move and remains in the first position P1. When the current increases and the magnetic attraction force between the first magnetizer 40 and the second magnetizer 55 exceeds the threshold, that is, greater than the coupling force between the first engaging member 810 and the second engaging member 820, the second engaging member 820 moves to the released position relative to the first engaging member 810. Since the second engaging member 820 disengages from the first engaging member 810, the first magnetizer 40 is attracted by the magnetic force and moves until it reaches the second position P2.

In this embodiment, the first engaging member 810 and the second engaging member 820 are magnetically connected. For example, the magnetic attraction force between the first engaging member 810 and the second engaging member 820 can be 20N, meaning that the threshold is 20N. When the magnetic attraction force between the first magnetizer 40 and the second magnetizer 55 is less than or equal to 20N, the first engaging member 810 and the second engaging member 820 remain magnetically connected, keeping the first magnetizer 40 in the first position P1. When the magnetic attraction force between the first magnetizer 40 and the second magnetizer 55 exceeds 20N, the second engaging member 820 disengages from the first engaging member 810, causing the first magnetizer 40 to move. During the movement of the first magnetizer 40 from the first position P1 to the second position P2, the distance between the first engaging member 810 and the second engaging member 820 gradually increases, reducing the magnetic attraction force between them. Thus, the magnetic attraction force between the first engaging member 810 and the second engaging member 820 does not affect the movement of the first magnetizer 40 from the first position P1 to the second position P2, resulting in faster response speed and higher sensitivity to short-circuit conditions.

As an example, one of the first engaging member 810 and the second engaging member 820 is a permanent magnet, and the other is an iron block. Specifically, the permanent magnet can be fixedly connected to the holding member 42, for example, by welding or adhesive, while the iron block can be fixedly connected to the first magnetizer 40, for example, by welding or adhesive. Of course, the permanent magnet can also be fixedly connected to the first magnetizer 40, and the iron block can be fixedly connected to the holding member 42.

Of course, in other embodiments, both the first engaging member 810 and the second engaging member 820 can also be permanent magnets, with opposite polarities enabling mutual attraction.

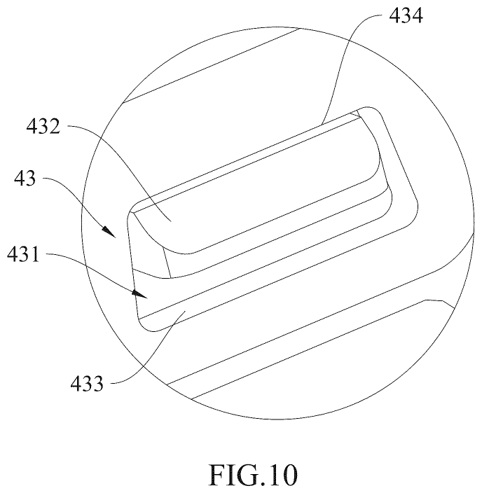

As shown in FIG. 2 and FIG. 10, FIG. 10 shows a partial enlarged view of part Z in FIG. 2. The first magnetizer 40 is movably connected to the holding member 42 through a limiting structure 43, which is used to restrict the movement of the first magnetizer 40 relative to the holding member 42 from the first position P1 to the second position P2.

The limiting structure 43 includes a limiting groove 431 and a limiting block 432. The limiting groove 431 is formed on one of the first magnetizer 40 and the holding member 42, and the limiting groove 431 extends along the movement direction D1 of the movable contact piece 54. The limiting block 432 is formed on the other of the first magnetizer 40 and the holding member 42, and the limiting block 432 is slidably engaged with the limiting groove 431.

In this embodiment, the limiting groove 431 is formed on the holding member 42. The limiting block 432 is formed on the first magnetizer 40. Specifically, the limiting block 432 protrudes from a side of the first magnetizer 40.

Of course, in other embodiments, the limiting groove 431 can also be formed on the first magnetizer 40, and the limiting block 432 can be formed on the holding member 42.

When the first magnetizer 40 is in the first position P1, there is a first gap between the limiting block 432 and the wall of the limiting groove 431. When the first magnetizer 40 is in the second position P2, there is a second gap between the limiting block 432 and the wall of the limiting groove 431. The first gap is smaller than the second gap.

Since the first gap is smaller than the second gap, the size of the limiting groove 431 presents a structure that a structure that one end is big and the other end is small Therefore, during the movement of the first magnetizer 40 from the first position P1 to the second position P2, the gap between the limiting block 432 and the wall of the limiting groove 431 increases, preventing friction and jamming between the limiting block 432 and the wall of the limiting groove 431.

As shown in FIG. 8 and FIG. 9, the wall of the limiting groove 431 near the second magnetizer 55 has a stopping wall 433. When the first magnetizer 40 moves to the second position P2, the stopping wall 433 stops against the limiting block 432. At this point, the distance between the first magnetizer 40 and the second magnetizer 55 is the second distance H2. By having the stopping wall 433 stop against the limiting block 432, the first magnetizer 40 is fixed relative to the contact container 10, providing a stable and reliable magnetic attraction force on the second magnetizer 55, meeting the requirements for anti-short circuit.

It is understandable that when the first magnetizer 40 moves to the second position P2, that is, when the stopping wall 433 stops against the limiting block 432, the first magnetizer 40 and the second magnetizer 55 can either be in contact or spaced apart. When the first magnetizer 40 and the second magnetizer 55 are in contact, the second distance H2 can be considered equal to zero.

As shown in FIG. 6 and FIG. 7, when the first magnetizer 40 is in the first position P1, under the magnetic attraction force between the first engaging member 810 and the second engaging member 820, the first magnetizer 40 abuts against the holding member 42, while the limiting block 432 is spaced apart from the limiting wall 434 of the limiting groove 431, ensuring that the first magnetizer 40 is stably held in the holding member 42.

Of course, in other embodiments, the way that the first magnetizer 40 is held in the holding member 42 can also be: under the magnetic attraction force between the first engaging member 810 and the second engaging member 820, the limiting block 432 can abut against the limiting wall 434 of the limiting groove 431, which is opposite to the stopping wall 433.

As shown in FIG. 5, FIG. 6, and FIG. 8, the relay also includes a connector 30, which passes through the second through-hole 103 and includes a first end 31 and a second end 32. The first end 31 is connected to the contact container 10, and the second end 32 is connected to the holding member 42.

The contact container 10 is provided with the second through-hole 103, and the connector 30 passes through the second through-hole 103, connecting the connector 30 to the contact container 10, and the holding member 42 is connected to the connector 30. Through the connector 30, the first magnetizer 40 is set on the holding member 42, which is fixed relative to the contact container 10, ensuring that the holding force of the first magnetizer 40 is provided by the contact container 10. This effectively increases the upper limit of the ability of short-circuits current, ensuring the reliability of anti-short circuit. The holding member 42 is connected to the contact container 10 through the connector 30, rather than directly, making the connection process unobstructed and visible, which not only facilitates operation but also ensures the reliability of the connection.

Furthermore, both the first through-hole 102 and the second through-hole 103 are provided on the top wall 111 of the ceramic cover 11, and the first end 31 of the connector 30 is connected to the outer wall surface of the top wall 111.

On the outer wall surface of the top wall 111, a first metallization layer 113 is provided around the periphery of the first through-hole 102, and a second metallization layer 114 is provided around the periphery of the second through-hole 103. The static lead-out terminals 20 are welded to the top wall 111 through the first metallization layer 113, and the first end 31 of the connector 30 is welded to the top wall 111 through the second metallization layer 114.

Compared to the inner wall surface of the ceramic cover 11, the outer wall surface of the top wall 111 is easier to form a welding plane. Additionally, since the top wall 111 of the ceramic cover 11 needs to accommodate the static lead-out terminals 20, and the static lead-out terminals 20 need to be welded to the top wall 111, a metallization layer is also required around the periphery of the first through-hole 102. Therefore, when processing the first metallization layer 113 for the first through-hole 102, the second metallization layer 114 for the second through-hole 103 is processed simultaneously. Thus, by welding the connector 30 to the outer wall surface of the top wall 111, metallization layers need only be processed on the outer wall surface of the top wall 111, eliminating the need for metallization layers on the inner wall surface. This simplifies the processing steps and makes the process more convenient.

The holding member 42 is spaced apart from the inner wall surface of the top wall 111. By spacing the holding member 42 apart from the inner wall surface of the top wall 111, a gap is created between them. Since the holding member 42 does not directly contact the inner wall surface of the top wall 111, the arrangement of the holding member 42 does not affect the creepage distance of the pair of static lead-out terminals 20.

In one embodiment, the top wall 111 and the side wall 112 are separate structures and are connected by welding.

It should be understood that designing the ceramic cover 11 with separate top wall 111 and a side wall 112 makes it easier to connect the connector 30 to the top wall 111. Of course, the top wall 111 and the side wall 112 can also be connected by adhesive bonding.

Specifically, since the top wall 111 is plate-shaped, it is easier to process the first through-hole 102, the second through-hole 103, the first metallization layer 113, and the second metallization layer 114 on the top wall 111. Furthermore, the plate-shaped structure also facilitates the welding of the connector 30 to the top wall 111 and the static lead-out terminals 20 to the top wall 111.

The connection between the second end 32 of the connector 30 and the holding member 42 can be implemented in various ways, such as welding, riveting, or adhesive bonding.

In another embodiment, the top wall 111 and the side wall 112 may also be of an integrated structure.

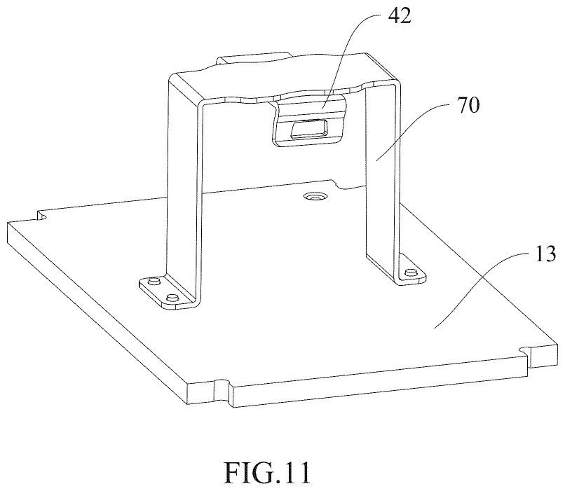

As shown in FIG. 11, FIG. 11 illustrates a schematic diagram of the holding member 42 fixedly connected to the fixing frame 70. The method for fixing the holding member 42 relative to the contact container 10 includes, in addition to the aforementioned approach of fixedly connecting the holding member 42 to the ceramic cover 11, the holding member 42 can also be fixedly connected to a fixing frame 70.

Specifically, the relay further includes a fixing frame 70, which is disposed within the contact chamber 101 and fixedly connected to the yoke plate 13. The holding member 42 is fixedly connected to the fixing frame 70.

In one embodiment, the holding member 42 is located between the pair of static lead-out terminals 20. By positioning the holding member 42 between the pair of static lead-out terminals 20, excessive occupation of space within the contact chamber 101 is avoided, contributing to the miniaturization of the relay.

In one embodiment, the holding member 42 is made of metal to enhance its structural strength.

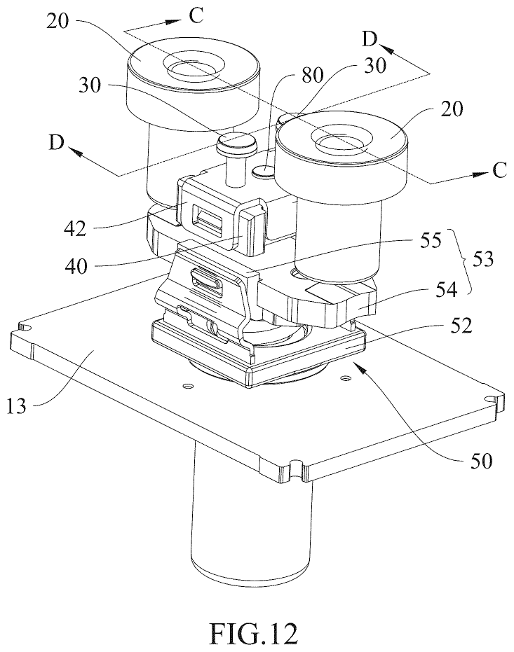

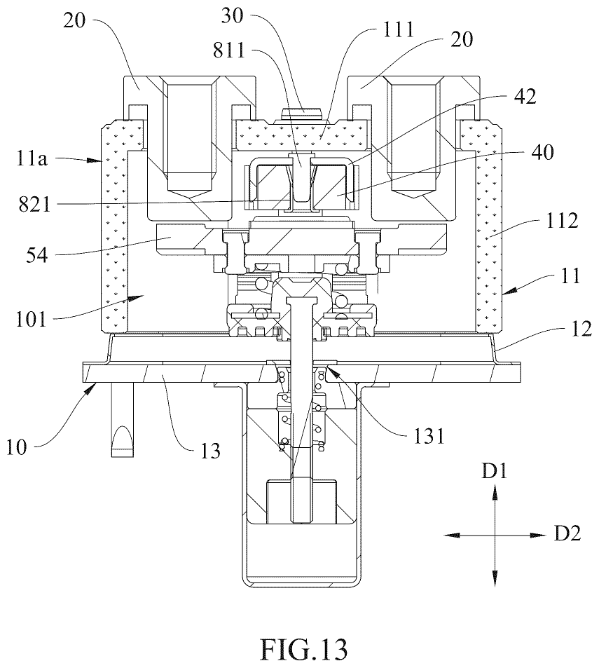

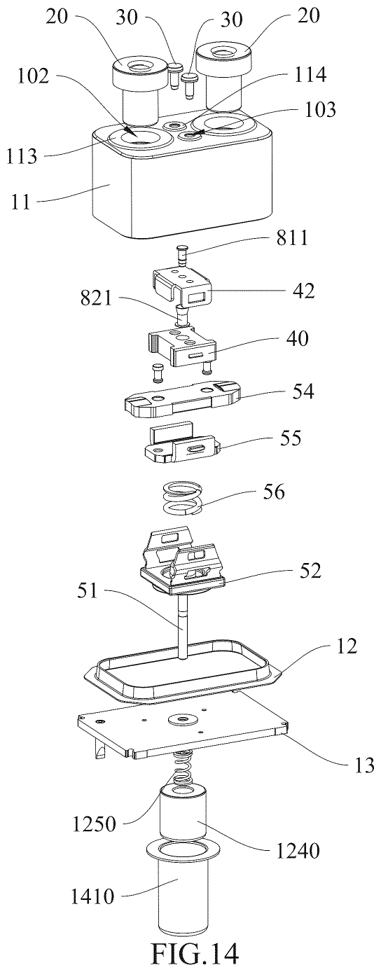

As shown in FIGS. 12 to 14, FIG. 12 illustrates a perspective schematic diagram of the relay according to the second embodiment of the present disclosure, with the housing, the electromagnetic unit, the arc extinguishing unit, the ceramic cover 11, and the frame member 12 removed. FIG. 13 shows a cross-sectional view taken along line C-C in FIG. 12 after assembling the ceramic cover and frame member. FIG. 14 shows an exploded schematic diagram of FIG. 12. The similarities between the second embodiment and the first embodiment will not be repeated, and the differences are as follows: the first engaging member 810 and the second engaging member 820 are connected by a snap-fit connection.

For example, the snap-fit force between the first engaging member 810 and the second engaging member 820 may be 20N, i.e., the threshold is 20N. When the magnetic attraction force between the first magnetizer 40 and the second magnetizer 55 is less than or equal to 20N, the first engaging member 810 and the second engaging member 820 remain snap-fitted, keeping the first magnetizer 40 in the first position P1. When the magnetic attraction force between the first magnetizer 40 and the second magnetizer 55 exceeds 20N, the second engaging member 820 is separated from the first engaging member 810, causing the first magnetizer 40 to move. Since the snap-fit connection between the first engaging member 810 and the second engaging member 820 is already separated away, the movement of the first magnetizer 40 from the first position P1 to the second position P2 is not affect by the snap-fit connection structure, resulting in faster response speed and higher sensitivity to short-circuit conditions.

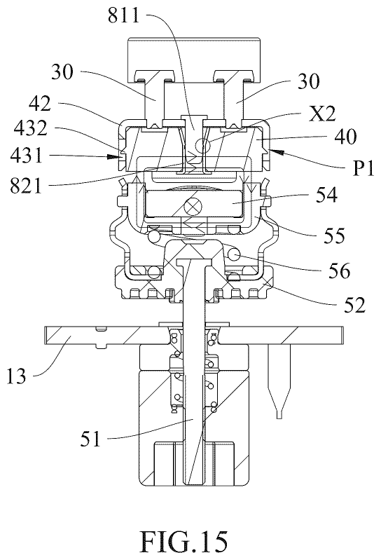

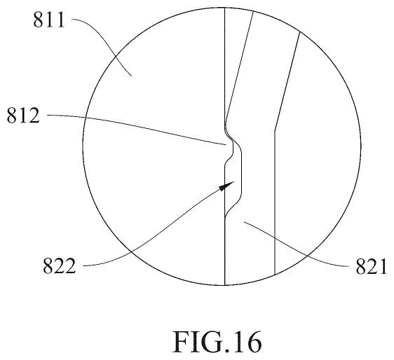

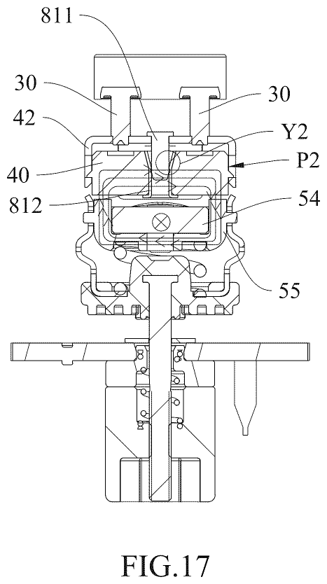

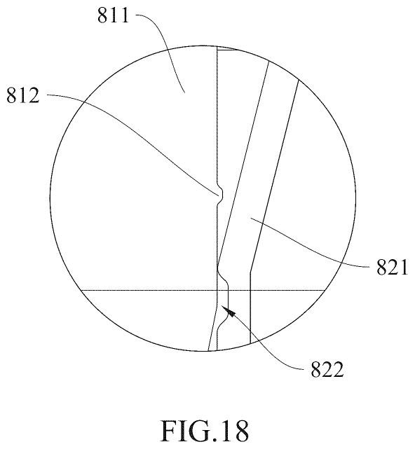

As shown in FIGS. 15 to 18, FIG. 15 shows a cross-sectional view taken along line D-D in FIG. 12, with the first magnetizer 40 in the first position P1. FIG. 16 shows a partial enlarged view of part X2 in FIG. 15. FIG. 17 shows a cross-sectional view taken along line D-D in FIG. 12, with the first magnetizer 40 in the second position P2. FIG. 18 shows a partial enlarged view of part Y2 in FIG. 17.

As an example, one of the first engaging member 810 and the second engaging member 820 includes a clamping post 811 and a convex bump 812 protruding from the outer periphery of the clamping post 811. The other of the first engaging member 810 and the second engaging member 820 includes a clamping sleeve 821 and a clamping groove 822 recessed on the inner peripheral wall of the clamping sleeve 821. The clamping post 811 is inserted into the clamping sleeve 821, and the convex bump 812 is engaged with the clamping groove 822.

In this embodiment, the first engaging member 810 includes the clamping post 811 and the convex bump 812, with the convex bump 812 protruding from the outer periphery of the clamping post 811, and the clamping post 811 is connected to the holding member 42. The second engaging member 820 includes the clamping sleeve 821 and the clamping groove 822, with the clamping groove 822 recessed on the inner peripheral wall of the clamping sleeve 821, and the clamping sleeve 821 is connected to the first magnetizer 40.

As shown in FIGS. 15 and 16, the clamping post 811 is inserted into the clamping sleeve 821, and the convex bump 812 is engaged with the clamping groove 822. Thus, when the magnetic attraction force between the first magnetizer 40 and the second magnetizer 55 is less than or equal to the snap-fit force between the convex bump 812 and the clamping groove 822, the first magnetizer 40 does not move toward the second magnetizer 55 but remains in the first position P1, i.e., the distance between the first magnetizer 40 and the second magnetizer 55 is the first distance H1.

As shown in FIGS. 17 and 18, when the magnetic attraction force between the first magnetizer 40 and the second magnetizer 55 exceeds the snap-fit force between the convex bump 812 and the clamping groove 822, the convex bump 812 disengages from the clamping groove 822, causing the clamping post 811 to move relative to the clamping sleeve 821, and thus the first magnetizer 40 moves from the first position P1 to the second position P2. When the first magnetizer 40 is in the second position P2, the distance between the first magnetizer 40 and the second magnetizer 55 is the second distance H2.

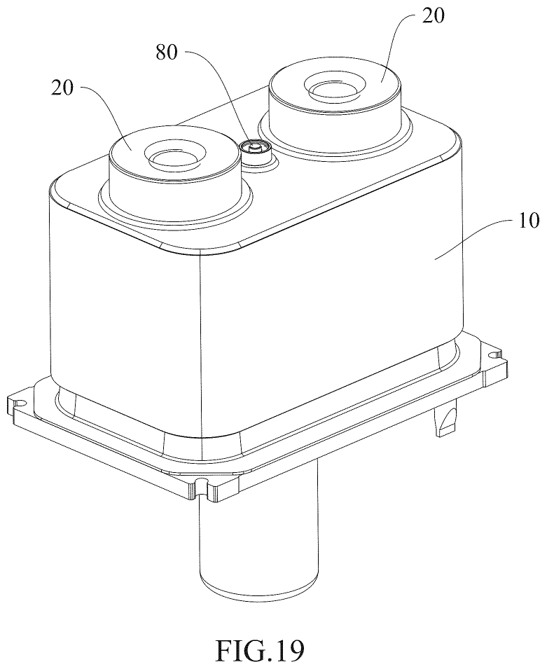

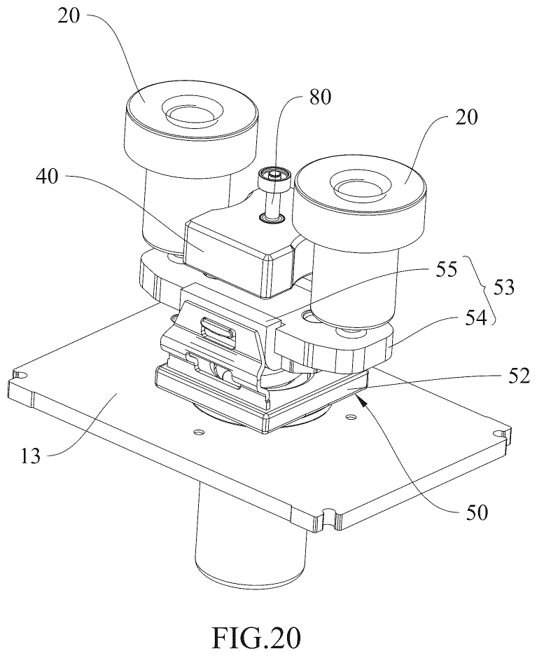

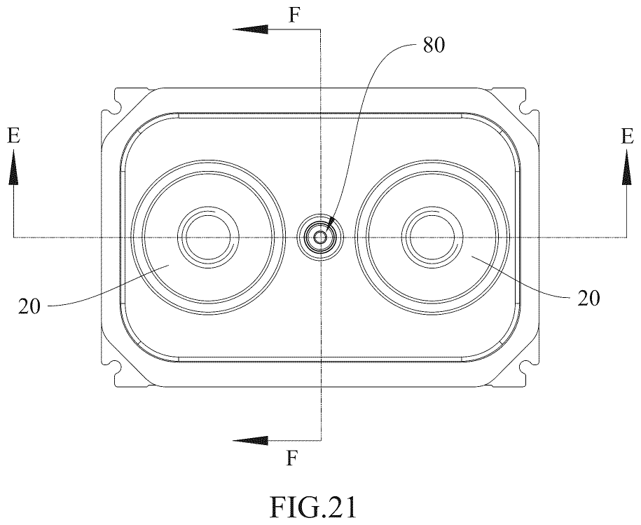

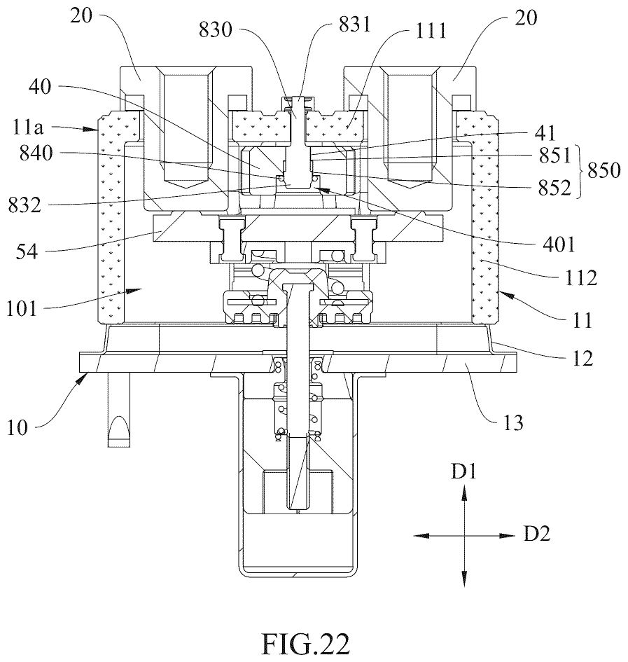

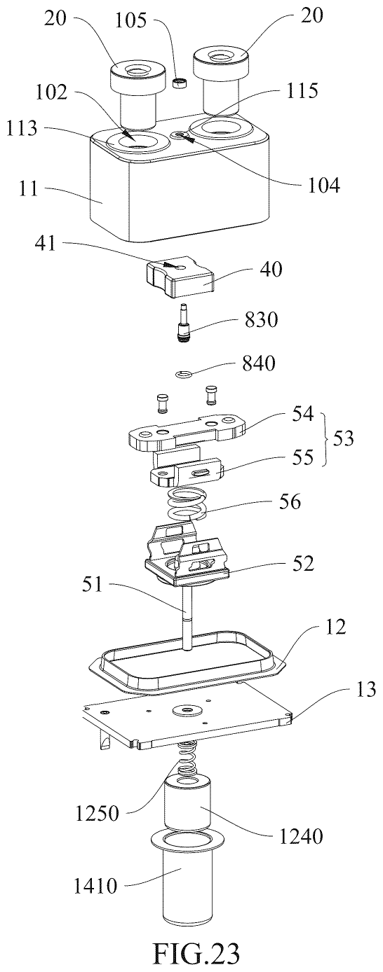

As shown in FIGS. 19 to 23, FIG. 19 illustrates a perspective schematic diagram of the relay according to the third embodiment of the present disclosure, with the housing, the electromagnetic unit, the arc extinguishing unit, the ceramic cover, and the frame member removed. FIG. 20 shows a schematic diagram of FIG. 19 with the ceramic cover 11 and the frame member 12 removed. FIG. 21 shows a top view schematic diagram of FIG. 19. FIG. 22 shows a cross-sectional view taken along line E-E in FIG. 21. FIG. 23 shows an exploded schematic diagram of FIG. 19. The similarities between the third embodiment and the first embodiment will not be repeated, and the differences are as follows:

The first magnetizer 40 has a through-hole 41. The first engaging member 810 includes a guide post 830, which is passed through the through-hole 41 and is fixed relative to the contact chamber 101. The second engaging member 820 includes an elastic snap ring 840, which is movably sleeved on the end of the guide post 830 closer to the second magnetizer 55. In the locked position, the elastic snap ring 840 prevents the first magnetizer 40 from moving toward the second magnetizer 55 relative to the guide post 830.

It should be understood that in this embodiment, the threshold can be considered as the sum of the elastic preload of the elastic snap ring 840 clamping the guide post 830 and the frictional force between the elastic snap ring 840 and the guide post 830.

Specifically, the elastic snap ring 840 has an elastic preload, which allows it to clamp onto the outer periphery of the guide post 830 and prevent the first magnetizer 40 from moving toward the second magnetizer 55 relative to the guide post 830. When the magnetic attraction force between the first magnetizer 40 and the second magnetizer 55 is less than or equal to the sum of the elastic preload of the elastic snap ring 840 and the frictional force between the elastic snap ring 840 and the guide post 830, the first magnetizer 40 is restrained and remains in the first position P1. When the magnetic attraction force between the first magnetizer 40 and the second magnetizer 55 exceeds the threshold (the frictional force between the elastic snap ring 840 and the guide post 830), the magnetic attraction force can attract the first magnetizer 40 to move relative to the guide post 830. Simultaneously, the first magnetizer 40 can drive the elastic snap ring 840 to disengage from its initial clamping position on the guide post 830.

The first magnetizer 40 is provided with a groove 401 on the side facing the second magnetizer 55, and the groove 401 is in communication with the through-hole 41. When the first magnetizer 40 is in the first position P1, the elastic snap ring 840 and the end of the guide post 830 closer to the second magnetizer 55 are both accommodated within the groove 401. Additionally, the elastic snap ring 840 abuts against the bottom of the groove 401.

The arrangement of the groove 401 allows the elastic snap ring 840 and the end of the guide post 830 closer to the second magnetizer 55 to be concealed within the groove 401, preventing them from being exposed on the surface of the first magnetizer 40 facing the second magnetizer 55. This prevents the exposed parts of the elastic snap ring 840 and the guide post 830 from interfering with the movement of the first magnetizer 40 from the first position P1 to the second position P2.

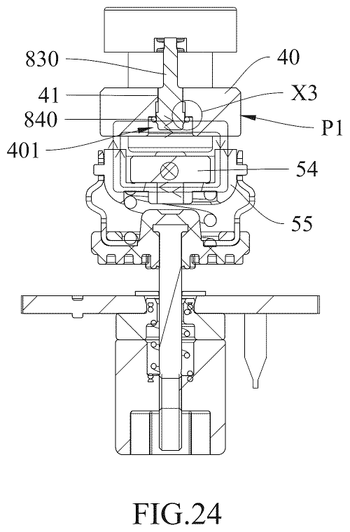

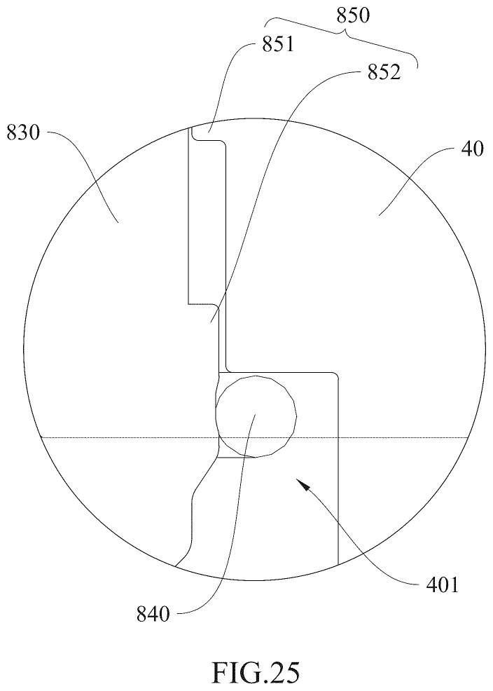

As shown in FIGS. 24 and 25, FIG. 24 illustrates a cross-sectional view taken along line F-F in FIG. 21, with the ceramic cover and the frame member removed, and the first magnetizer 40 in the first position P1. FIG. 25 shows a partial enlarged view of part X3 in FIG. 24. When the first magnetizer 40 is in the first position P1, the elastic snap ring 840 clamps onto the outer periphery of the guide post 830 and abuts against the bottom wall of the groove 401 of the first magnetizer 40.

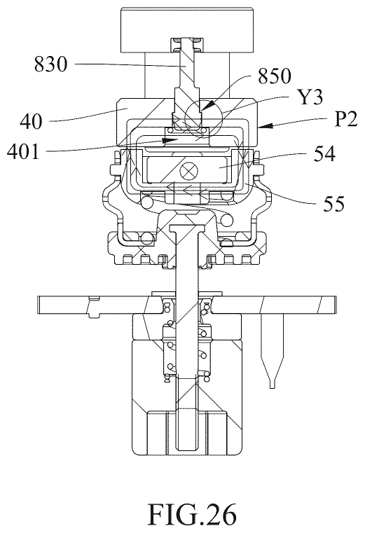

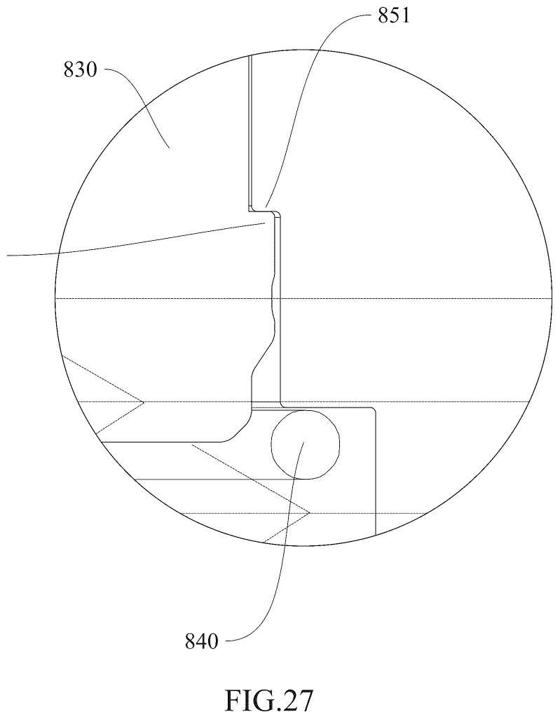

As shown in FIGS. 26 and 27, FIG. 26 illustrates a cross-sectional view taken along line F-F in FIG. 21, with the ceramic cover and the frame member removed, and the first magnetizer 40 in the second position P2. FIG. 27 shows a partial enlarged view of part Y3 in FIG. 26. A stopping structure 850 is further provided between the guide post 830 and the first magnetizer 40, which is used to stop the first magnetizer 40 at the second position P2 when the elastic snap ring 840 is in the released position.

When the magnetic attraction force between the first magnetizer 40 and the second magnetizer 55 exceeds the threshold, the first magnetizer 40 moves from the first position P1 to the second position P2. The stopping structure 850 ensures that the first magnetizer 40 remains in the second position P2.

It should be understood that after the first magnetizer 40 moves from the first position P1 to the second position P2, the elastic snap ring 840 may still clamp onto the guide post 830 or may detach from it.

The stopping structure 850 includes a first stopping portion 851 and a second stopping portion 852. The first stopping portion 851 is provided within the through-hole 41 of the first magnetizer 40, and the second stopping portion 852 is provided on the guide post 830. When the first magnetizer 40 is in the second position P2, the first stopping portion 851 and the second stopping portion 852 abut against each other.

As an example, the wall of the through-hole 41 of the first magnetizer 40 may have a stepped structure, and the outer peripheral wall of the guide post 830 may also have a stepped structure. The two stepped structures are matched to achieve the stopping function.

As shown in FIGS. 23, 24, and 26, the contact container 10 further has a fourth through-hole 104, which is in communication with the contact chamber 101. The guide post 830 is passed through the fourth through-hole 104 and includes a third end 831 and a fourth end 832. The third end 831 is connected to the contact container 10, and the elastic snap ring 840 is sleeved on the fourth end 832.

As an example, the third end 831 of the guide post 830 may be connected to the contact container 10 through a welding terminal 105.

The contact container 10 is provided with the fourth through-hole 104, and the guide post 830 is passed through the fourth through-hole 104, connecting the guide post 830 to the contact container 10 and the first magnetizer 40 to the guide post 830. By connecting the first magnetizer 40 to the contact container 10 through the guide post 830 rather than directly, the connection process is unobstructed and visible, facilitating operation and ensuring the reliability of the connection.

Thus, the third end 831 of the guide post 830 can be connected to the contact container 10, and the fourth end 832 of the guide post 830 can cooperate with the elastic snap ring 840. By providing a single guide post 830, the movement of the first magnetizer 40 from the first position P1 to the second position P2 is achieved, and the first magnetizer 40 is connected to the contact container 10, simplifying assembly and saving material costs.

As an example, the fourth through-hole 104 is provided on the top wall 111 of the ceramic cover 11. The fourth through-hole 104 may be located between the two first through-holes 102; meaning that the guide post 830 is arranged between the pair of static lead-out terminals 20.

The first through-hole 102 and the fourth through-hole 104 are provided on the top wall 111, and the third end 831 of the guide post 830 is connected to the outer wall surface of the top wall 111.

On the outer wall surface of the top wall 111, a first metallization layer 113 is provided around the periphery of the first through-hole 102, and a third metallization layer 115 is provided around the periphery of the fourth through-hole 104. The static lead-out terminals 20 are welded to the top wall 111 through the first metallization layer 113, and the third end 831 of the guide post 830 is welded to the top wall 111 through the third metallization layer 115.

Compared to the inner wall surface of the ceramic cover 11, the outer wall surface of the top wall 111 is easier to form a welding plane. Additionally, since the top wall 111 of the ceramic cover 11 needs to accommodate the static lead-out terminals 20, and the static lead-out terminals 20 need to be welded to the top wall 111, a metallization layer is also required around the periphery of the first through-hole 102. Therefore, when processing the first metallization layer 113 for the first through-hole 102, the third metallization layer 115 for the fourth through-hole 104 is processed simultaneously. Thus, by welding the guide post 830 to the outer wall surface of the top wall 111, metallization layers need only be processed on the outer wall surface of the top wall 111, eliminating the need for metallization layers on the inner wall surface. This simplifies the processing steps and makes the process more convenient.

The first magnetizer 40 is spaced apart from the inner wall surface of the top wall 111. By spacing the first magnetizer 40 apart from the inner wall surface of the top wall 111, a gap is created between them. Since the first magnetizer 40 does not directly contact the inner wall surface of the top wall 111, the arrangement of the first magnetizer 40 does not affect the creepage distance of the pair of static lead-out terminals 20.

In one embodiment, the top wall 111 and the side wall 112 of the ceramic cover 11 are separate structures and are connected by welding.

It should be understood that designing the ceramic cover 11 with separate top wall 111 side wall and the side wall 112 makes it easier to connect the guide post 830 to the top wall 111. Of course, in other embodiments, the top wall 111 and the side wall 112 can also be connected by adhesive bonding.

Specifically, since the top wall 111 is plate-shaped, it is easier to process the first through-hole 102, the fourth through-hole 104, the first metallization layer 113, and the third metallization layer 115 on the top wall 111. Furthermore, the plate-shaped structure also facilitates the welding of the guide post 830 to the top wall 111 and the static lead-out terminals 20 to the top wall 111.

It should be understood that, in addition to being fixedly connected to the top wall 111 of the ceramic cover 11, the guide post 830 can also be fixedly connected to a fixing frame 70, which is disposed within the contact chamber 101 and fixedly connected to the yoke plate 13. For specific details, refer to the arrangement of the fixing frame 70 in the relay of the first embodiment of the present disclosure, which will not be repeated here.

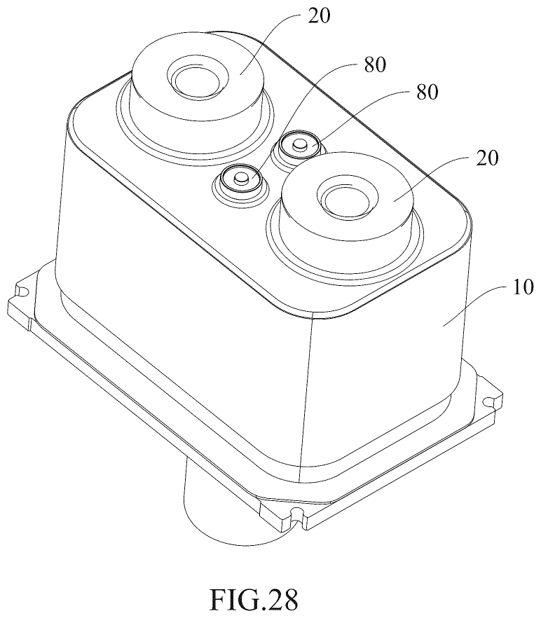

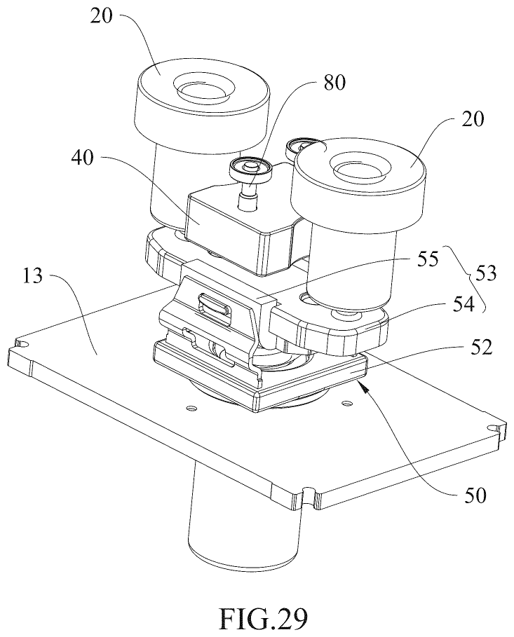

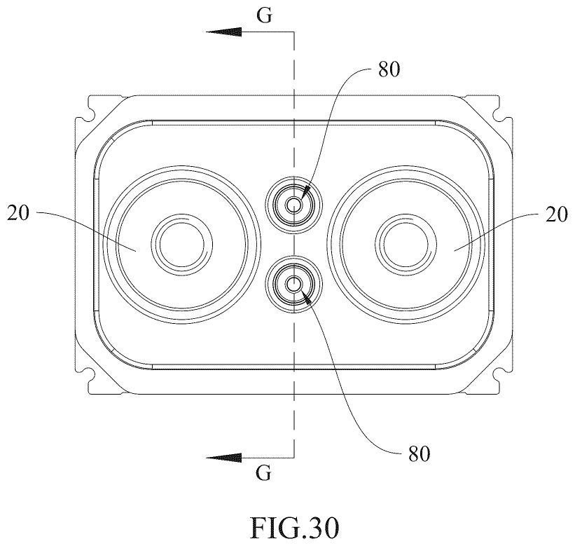

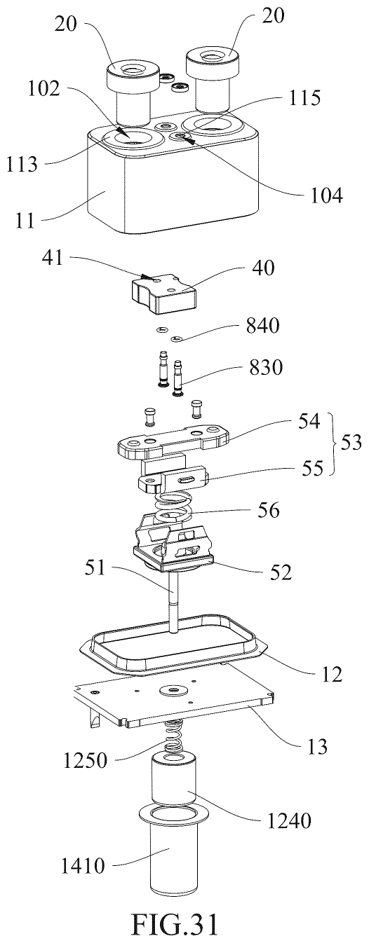

As shown in FIGS. 28 to 35, the similarities between the fourth embodiment and the third embodiment will not be repeated, and the differences are as follows: in the released position, the elastic snap ring 840 is clamped between the first magnetizer 40 and the second stopping portion 852.

Specifically, the first stopping portion 851 of the stopping structure 850 is provided around the periphery of the through-hole 41, and the second stopping portion 852 is provided on the fourth end 832 of the guide post 830.

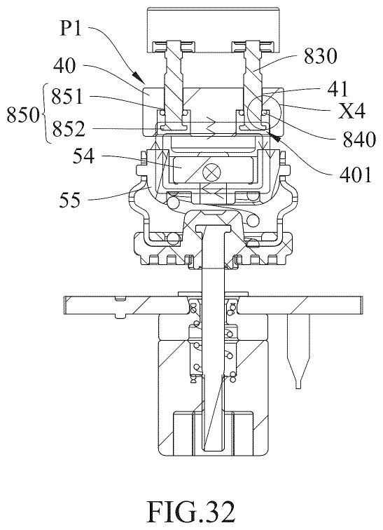

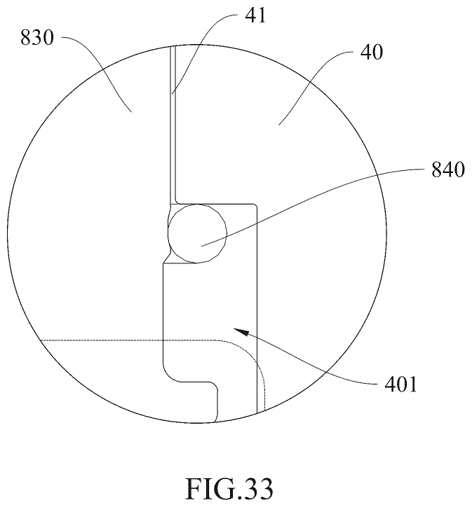

As shown in FIGS. 32 and 33, when the first magnetizer 40 is in the first position P1, the elastic snap ring 840 clamps onto the outer periphery of the guide post 830 and abuts against the first stopping portion 851, keeping the first magnetizer 40 in the first position P1. Additionally, at this point, both the elastic snap ring 840 and the second stopping portion 852 are located within the groove 401 of the first magnetizer 40.

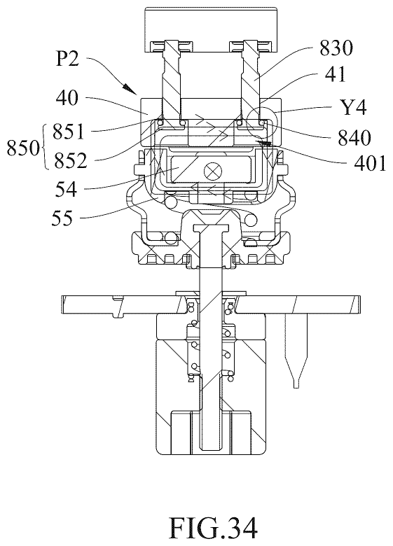

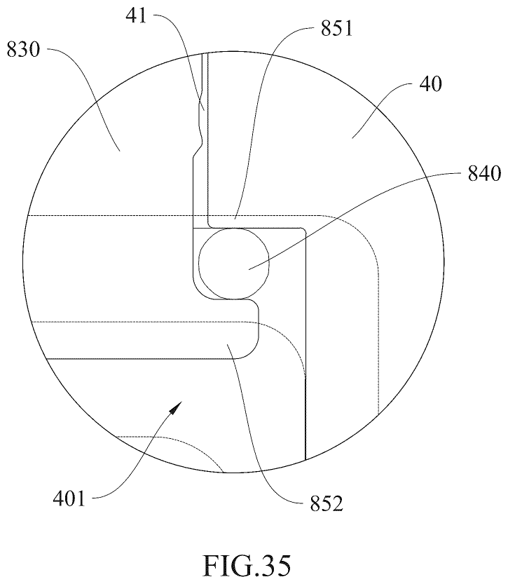

As shown in FIGS. 34 and 35, during the movement of the first magnetizer 40 from the first position P1 to the second position P2, the elastic snap ring 840 moves toward the fourth end 832 of the guide post 830 until it contacts the second stopping portion 852. When the first magnetizer 40 moves to the second position P2, the elastic snap ring 840 is clamped between the first stopping portion 851 and the second stopping portion 852.

At least one embodiment of the above disclosure has the following advantages or beneficial effects:

The relay of the present disclosure, on one hand, has a first magnetizer movably disposed within the contact chamber, allowing the distance between the first magnetizer and the second magnetizer to be adjusted according to the current value, thereby changing the magnetic attraction force generated between the first magnetizer and the second magnetizer, which not only meets the breaking requirements but also satisfies anti-short circuit requirements. On the other hand, the first magnetizer is connected to the contact container through the tripping assembly, and when the magnetic attraction force between the first magnetizer and the second magnetizer exceeds a threshold, the tripping assembly releases the first magnetizer, thereby adjusting the magnetic gap between the first magnetizer and the second magnetizer. With the tripping assembly, the movement response speed of the first magnetizer is faster, and the sensitivity to short-circuit conditions is higher.

It should be understood that the various embodiments/implementations provided in the present disclosure can be combined without causing contradictions, and examples will not be listed here.

In the present disclosure, the terms “first” “second” and “third” are used for descriptive purposes only and should not be construed as indicating or implying relative importance. The terms “pair” and “one” are used to introduce technical features and should not be construed as limiting the specific quantity of the technical feature unless explicitly stated. The term “multiple” refers to two or more unless explicitly stated. Terms such as “install” “connect” “link” and “fix” should be interpreted broadly. For example, “connect” can mean fixed connection, detachable connection, or integral connection; “link” can mean direct connection or indirect connection through an intermediate medium. For those skilled in the art, the specific meanings of the above terms in the present disclosure can be understood based on the context.

In the description of the present disclosure, it should be understood that terms such as “upper” “lower” “left” “right” “front” and “rear” indicate orientations or positional relationships based on the orientations or positional relationships shown in the drawings. These terms are used to facilitate the description of the present disclosure and simplify the description, and do not indicate or imply that the device or unit must have a specific orientation or be constructed and operated in a specific orientation. Therefore, these terms should not be construed as limiting the present disclosure.

In the description of this specification, terms such as “one embodiment” “some embodiments” and “specific embodiment” mean that specific features, structures, materials, or characteristics described in connection with the embodiment or example are included in at least one embodiment or example of the present disclosure. In this specification, the schematic descriptions of the above terms do not necessarily refer to the same embodiment or example. Moreover, the specific features, structures, materials, or characteristics described may be combined in any suitable manner in one or more embodiments or examples.

The above are only preferred embodiments of the present disclosure and are not intended to limit the present disclosure. For those skilled in the art, the present disclosure may have various modifications and changes. Any modifications, equivalent replacements, or improvements made within the spirit and principles of the present disclosure shall be included within the scope of protection of the present disclosure.

1-25. (canceled)

26. A relay, comprising:
a contact container having a contact chamber;
a pair of static lead-out terminals fixedly disposed relative to the contact container;
a first magnetizer movably disposed within the contact chamber, and having a first position and a second position relative to the contact container;
a movable member comprising a movable contact piece and a second magnetizer, wherein both ends of the movable contact piece are configured to come into contact with or separate from the pair of static lead-out terminals;
the first magnetizer is disposed at a side of the movable contact piece facing the static lead-out terminals, and the second magnetizer is fixedly disposed at a side of the movable contact piece facing away from the static lead-out terminals, the second magnetizer is configured to form a magnetic circuit with the first magnetizer;
in the first position, a distance between the first magnetizer and the second magnetizer is a first distance, and in the second position, a distance between the first magnetizer and the second magnetizer is a second distance, the first distance is greater than the second distance; and
a tripping assembly, wherein the first magnetizer is connected to the contact container through the tripping assembly, and the tripping assembly is configured to release the first magnetizer when a magnetic attraction force between the first magnetizer and the second magnetizer exceeds a threshold.

27. The relay according to claim 26, wherein the pair of static lead-out terminals are connected to the contact container, at least a portion of each of the static lead-out terminals is located within the contact chamber.

28. The relay according to claim 26,
wherein the first magnetizer is in the first position when a current flowing through the movable contact piece is less than or equal to a threshold current; and
when a current flowing through the movable contact piece exceeds the threshold current, the tripping assembly releases the first magnetizer, causing the first magnetizer to move from the first position to the second position under the magnetic attraction force.

29. The relay according to claim 26, wherein the tripping assembly comprises:
a first engaging member fixedly disposed relative to the contact container;
a second engaging member having a locked position and a released position relative to the first engaging member; and
wherein, in the locked position, the second engaging member is engaged with the first engaging member to keep the first magnetizer in the first position, and in the released position, the second engaging member is separated from the first engaging member, allowing the first magnetizer to move from the first position to the second position.

30. The relay according to claim 29, wherein the second engaging member is fixedly connected to the first magnetizer; the tripping assembly further comprises:
a holding member, at least partially disposed within the contact chamber and fixedly arranged relative to the contact container; the first engaging member is fixedly connected to the holding member.

31. The relay according to claim 30, wherein the first magnetizer is movably connected to the holding member through a limiting structure, the limiting structure is configured to restrict a movement of the first magnetizer relative to the holding member from the first position to the second position.

32. The relay according to claim 31, wherein the limiting structure comprises:
a limiting groove provided on one of the first magnetizer and the holding member, and extending along a movement direction of the movable contact piece; a stopping wall is provided at one end of the groove wall of the limiting groove closer to the second magnetizer; and
a limiting block provided on another of the first magnetizer and the holding member, the limiting block is slidably engaged with the limiting groove, and in the second position, the stopping wall abuts against the limiting block.

33. The relay according to claim 32, wherein
in the first position, a first gap exists between the limiting block and the groove wall of the limiting groove;
in the second position, a second gap exists between the limiting block and the groove wall of the limiting groove; and
the first gap is smaller than the second gap.

34. The relay according to claim 30, wherein the contact container further comprises a pair of first through-holes and a second through-hole, both the first through-holes and the second through-hole are in communication with the contact chamber; the pair of static lead-out terminals respectively pass through the pair of first through-holes; the relay further comprises a connector passing through the second through-hole, the connector comprises a first end and a second end, the first end is connected to the contact container, and the second end is connected to the holding member.

35. The relay according to claim 34, wherein the contact container comprises:
a yoke plate;
an insulating cover connected to the yoke plate; the insulating cover and the yoke plate enclose the contact chamber; and
wherein the first through-holes and the second through-hole are provided on the insulating cover, and the first end of the connector is connected to an outer wall surface of the insulating cover.

36. The relay according to claim 35, wherein
the insulating cover comprises a ceramic cover and a frame member, the ceramic cover comprises a top wall and a side wall, one end of the side wall is connected around a periphery of the top wall, and another end of the side wall is connected to the yoke plate through the frame member;
the first through-holes and the second through-hole are provided on the top wall; on an outer wall surface of the top wall, a first metallization layer is provided around a periphery of the first through-holes, and a second metallization layer is provided around a periphery of the second through-hole; and
the static lead-out terminals are welded to the top wall through the first metallization layer, and the first end of the connector is welded to the top wall through the second metallization layer.

37. The relay according to claim 35, wherein the holding member is spaced apart from an inner wall surface of the top wall.

38. The relay according to claim 30, wherein the contact container comprises:
a yoke plate;
an insulating cover connected to the yoke plate; the insulating cover and the yoke plate enclose the contact chamber; and
the relay further comprises a fixing frame disposed within the contact chamber and fixedly connected to the yoke plate, the holding member is fixedly connected to the fixing frame.

39. The relay according to claim 30, wherein the holding member is located between the pair of static lead-out terminals.

40. The relay according to claim 30, wherein the holding member is made of a metal material.

41. The relay according to claim 29, wherein
the second engaging member is fixedly connected to the first magnetizer, the first engaging member and the second engaging member are magnetically connected ; or
the second engaging member is fixedly connected to the first magnetizer, the first engaging member and the second engaging member are connected by a snap-fit connection.

42. The relay according to claim 41, wherein
one of the first engaging member and the second engaging member is a permanent magnet, and another is an iron block; or
one of the first engaging member and the second engaging member comprises a clamping post and a convex bump protruding from an outer periphery of the clamping post, another of the first engaging member and the second engaging member comprises a clamping sleeve and a clamping groove recessed on an inner peripheral wall of the clamping sleeve, the clamping post is inserted into the clamping sleeve, and the convex bump is engaged with the clamping groove.

43. The relay according to claim 29, wherein
the first magnetizer has an opening;
the first engaging member comprises a guide post passing through the opening and fixedly arranged relative to the contact container;
the second engaging member comprises an elastic snap ring movably sleeved on an end of the guide post closer to the second magnetizer; and
in the locked position, the elastic snap ring prevents the first magnetizer from moving toward the second magnetizer relative to the guide post.

44. The relay according to claim 43, wherein a stopping structure is further provided between the guide post and the first magnetizer, configured to stop the first magnetizer at the second position when the elastic snap ring is in the released position.

45. The relay according to claim 44, wherein the stopping structure comprises:
a first stopping portion provided on the first magnetizer;
a second stopping portion provided on the guide post; and
wherein, when the first magnetizer is in the second position, the first stopping portion and the second stopping portion abut against each other.

46. The relay according to claim 45, wherein
in the released position, the elastic snap ring is detached from the guide post; or
in the released position, the elastic snap ring is clamped between the first magnetizer and the second stopping portion.

47. The relay according to claim 43, wherein
a side of the first magnetizer facing the second magnetizer is provided with a groove, the groove is in communication with the opening; and
when the first magnetizer is in the first position, the elastic snap ring and an end of the guide post closer to the second magnetizer are accommodated in the groove.

48. The relay according to claim 26, wherein in the second position, the second distance between the first magnetizer and the second magnetizer is equal to zero.
